(19) United States
(12) Patent Application Publication
(10) Pub. No.: US 2010/0153885 A1
(43) Pub. Date: Jun. 17, 2010

(54) SYSTEMS AND METHODS FOR INTERACTING WITH ADVANCED DISPLAYS PROVIDED BY AN INTERACTIVE MEDIA GUIDANCE APPLICATION

(75) Inventor: DOUG YATES, Los Angeles, CA (US)

Correspondence Address: ROPES & GRAY LLP, PATENT DOCKETING 39/361, 1211 AVENUE OF THE AMERICAS, NEW YORK, NY, 10036-8704, US

(73) Assignee: Rovi Technologies Corporation, Santa Clara, CA (US)

(21) Appl. No.: 12/617,096

(22) Filed: Nov. 12, 2009

Related U.S. Application Data
(63) Continuation of application No. 11/324,202, filed on Dec. 29, 2005, now abandoned.

(51) Int. Cl. G06F 17/30; G06F 3/048

(52) U.S. Cl. 715/841; 707/723; 707/E17.014

(57) ABSTRACT

An interactive television application is used to provide search results to a user. The user is provided with an opportunity to indicate a desire to search for programs. In response, the interactive television application generates search criteria and searches for programs. The search results that are displayed to the user include mosaic listings associated with programs that match the search criteria. In some embodiments, the interactive television application displays the mosaic listings in a manner that accentuates the different levels of relevance of the search results to the search criteria.

### CROSS-REFERENCE TO RELATED APPLICATION

This application is a continuation of U.S. patent application Ser. No. 11/324,202, filed on Dec. 29, 2005, which is hereby incorporated by reference herein in its entirety.

### BACKGROUND OF THE INVENTION

A substantial amount of programs may be available to users in any given media delivery system. (As referenced herein, the terms “program” and “programs” include any and all types of media that the media guidance application may access, such as broadcast programs, recorded programs, movies, video clips, videos On Demand (VOD), pay-per-view (PPV) movies, music videos, satellite radio, data available via the Internet, images, icons, clipart, advertisements and/or promotional information.) This problem (i.e., that of a substantial amount of programs) is compounded when the user has access to a plurality of media delivery systems. Regardless of how many delivery systems the user may access, the vast number of choices may overwhelm even the most sophisticated user. Moreover, the user may not be able to efficiently search all the programs that are available to the user.

Consequently, many users desire a form of media guidance with an interface that allows users to efficiently search, navigate and access program selections, as well as easily identify programs that the users may desire. An application that provides a user the ability to search and navigate the search results is referred to herein as an interactive media guidance application or, sometimes, a guidance application. Additional examples of how the guidance application may allow the user to access programs from multiple sources are illustratively shown in Walker et al., U.S. Patent Application No. 60/755,749, filed Dec. 29, 2005 (attorney docket no. UV-344 Prov.) (referred to herein as “UV-344 Prov.”).

Interactive media guidance applications may take various forms depending on the type of programs for which they provide guidance. One typical type of media guidance application is an interactive television program guide. Interactive television program guides are well-known guidance applications that, among other things, allow users to navigate among and locate television programming viewing choices and, in some systems, digital music. The television (and music) programming may be provided via traditional broadcast, cable, or satellite. The programming may be provided on a subscription basis (sometimes referred to as premium programming), as pay-per-view programs, or on-demand such as in video-on-demand (VOD) systems.

In addition to subscribing to one or more types of programming (e.g., premium programming such as HBO), the user generally subscribes to only one media provider for each type of program (e.g., cable television, digital music, high speed internet, satellite radio, etc.) that the user receives. This generally limits the amount of programs available to the user. For example, a user who subscribes to Comcast cable television may only have access to the programs made available on demand by Comcast. Similarly a user who subscribes to Optimum for cable television may only have access to the programs made available on demand by Optimum. There is a need in the art for systems and methods that allow the user to search and access programs provided by different media providers regardless of which media providers or services the user subscribes (e.g., the Optimum user should have the ability to easily search and access programs only Comcast provides on demand).

Often guidance applications provide search results to the user in a list or grid display. This may overwhelm the user, especially when the user is presented with a large number of search results from multiple service providers. Moreover, the user may not be able to quickly determine whether the user is interested in a program included in the search results by simply reading the title and/or a short description of the program. There is a need to provide the user a more user-friendly display of search results that may also allow the user to quickly determine whether the user wants to access a program.

### SUMMARY OF THE INVENTION

In accordance with the principles of the present invention, an interactive media guidance application is provided that may present displays that include one or more mosaic listings. Mosaic listings may be related to programs. For example, a mosaic listing may be any image including, for example, box art of movies, cover art of compact discs, user generated images, clipart (downloaded or user created), a logo associated with the program and/or any other picture or video associated with the program (e.g., the image may be the video of the program or a frozen frame of the program). Mosaic listings may also be related to media guidance application features, non-media guidance application features and/or anything else that may be accessed via a media guidance application display screen. For simplicity, any program, interactive feature, website, application, etc. that may be linked to by a mosaic listing is generally referred to herein as a “program.”

In some embodiments, the mosaic listings may be arranged in a graphical manner to emphasize each listing's relative degree of relevancy (also referred to as the level of relevance). The degree of relevancy may be related to how similar the program associated with the mosaic listing is to certain criteria. The criteria may be based on user-entered or application-generated information. For example, the degree of relevancy may be related to search criteria. As another example, the criteria may be related to a user profile. As a third example, the degree of relevancy may be related to the user selection of a button on a remote control (discussed below, for example, in connection with FIG. 16) or the television being turned ON. For simplicity, the phrase “search criteria” is used herein to generally describe any information, user-indication, criterion, etc. that the degree of relevancy is based on.

Mosaic listings may be included in any media guidance application display. For example, displays that present search results or other types of program listings to the user may include mosaic listings. In some embodiments, mosaic listings may be limited to particular types of interactive media guidance application displays (e.g., only the default display that is provided when the user first enters the interactive media guidance application, only search result displays, only parentally controlled displays, etc.). For simplicity, search result displays are used herein to provide examples of the functionality and features that may be associated with displays that include mosaic listings.

In some embodiments, the interactive media guidance application may search for programs. The media guidance application may allow the user to input a first set of search criteria. In some embodiments the user may initially enter specific, detailed search criteria (such as a plurality of specific program attributes the user would like included among the search results). Although the media guidance application may automatically generate additional search criteria to supplement the user-entered search criteria, the user-entered search criteria may largely determine which search results are displayed by the guidance application.

In other embodiments, the user may initially enter less search criteria (e.g., only one or two attributes). In these other embodiments, the search criteria automatically generated by the media guidance application may play a more important role in which search results are provided to the user.

The interactive media guidance application may allow the user to configure a user profile. Regardless of whether the search criteria is predominantly user-entered or application-generated, the user profile may then assist the guidance application in the generation of search criteria. In some embodiments, the guidance application may automatically generate the user profile by, for example, monitoring the user's interactions with the media guidance application. In other embodiments, the user profile may be partly user-entered and partly automatically generated by the media guidance application.

The interactive media guidance application may display the search results in a graphical manner that emphasizes the most relevant search results. The relevancy of the search results may be directly correlated to similarities between the attributes of the search criteria and the program attributes that comprise the search results. In some embodiments, the guidance application may also consider the priority of one or more attributes when determining the relevancy of the search results. For example, a program that shares important attributes with the search criteria may be considered more relevant than programs that shares less important attributes with the search criteria. The priority of the attribute(s) may depend on, for example, the particular search, current user, active user profile and/or previous search(s).

The interactive media guidance application may also allow the user to select a program, that was initially provided to the user as a search result, to refine the search criteria. In some embodiments, the attributes of the first set of search criteria is compared to the attributes of the selected program and the guidance application uses this information to generate a second set of search criteria. In other embodiments, the guidance application simply supplements the first set of search criteria with the attributes of the selected program. In yet other embodiments, the media guidance application may perform a hybrid of the two approaches (i.e., (1) compare the attributes of the program with the attributes of the first set of search criteria and (2) supplement the first set of search criteria with the attributes of the selected program).

In some embodiments of the present invention, the interactive media application may search for both directly related attributes (e.g., title, actor, description, program type or any other attribute that is not time dependent) and indirectly related attributes (e.g., attributes that may be time dependent). For example, a search for programs (e.g., music, images, music videos, television programs and/or movies) that include Madonna as an attribute may also return programs that include Guy Ritchie as an attribute, because their current marriage may cause otherwise unrelated programs to be indirectly related. However, if their marriage were to end in divorce, the indirect association of such programs may thereafter be eliminated or be considered by the media guidance application as a less relevant attribute.

### BRIEF DESCRIPTION OF THE DRAWINGS

The above and other features of the present invention, its nature and various advantages will be more apparent upon consideration of the following detailed description, taken in conjunction with the accompanying drawings, in which like reference characters refer to like parts throughout, and in which:

FIG. 1 shows an illustrative main menu display in which a search option may be selected in accordance with certain embodiments of the present invention;

FIG. 2 shows an illustrative program information display in which a search option may be selected in accordance with certain embodiments of the present invention;

FIG. 3 shows an illustrative search display that allows the user to configure a search or to access other search menus in accordance with certain embodiments of the present invention;

FIG. 4 shows an illustrative display that may be used to configure the user profile in accordance with certain embodiments of the present invention;

FIG. 5 shows an illustrative program listings display screen that may be used to configure a user profile in accordance with certain embodiments of the present invention;

FIGS. 6-9 show illustrative displays of search results that are arranged in a graphical manner to emphasize the relative degree of relevancy to the search criteria;

FIG. 10a shows a data structure that is associated with a program available for a fee in accordance with certain embodiments of the present invention;

FIG. 10b shows a data structure that is associated with a broadcast program in accordance with certain embodiments of the present invention;

FIG. 11 is a flow diagram of an illustrative interactive media guidance application that provides the user with the ability to indicate a desire to search for programs in accordance with certain embodiments of the present invention;

FIG. 12 is a flow diagram of an illustrative interactive media guidance application for refining a set of search results in accordance with certain embodiments of the present invention;

FIG. 13 is a diagram of an illustrative interactive media guidance application in accordance with certain embodiments of the present invention;

FIG. 14 is a diagram of illustrative user television equipment in accordance with certain embodiments of the present invention;

FIG. 15 is a diagram of additional illustrative user television equipment in accordance with certain embodiments of the present invention;

FIG. 16 is a diagram of an illustrative remote control in accordance with certain embodiments of the present invention;

FIG. 17 is a diagram of illustrative user computer equipment in accordance with certain embodiments of the present invention; and

FIG. 18 is a generalized diagram of illustrative user equipment in accordance with certain embodiments of the present invention.

### DETAILED DESCRIPTION OF THE PREFERRED EMBODIMENTS

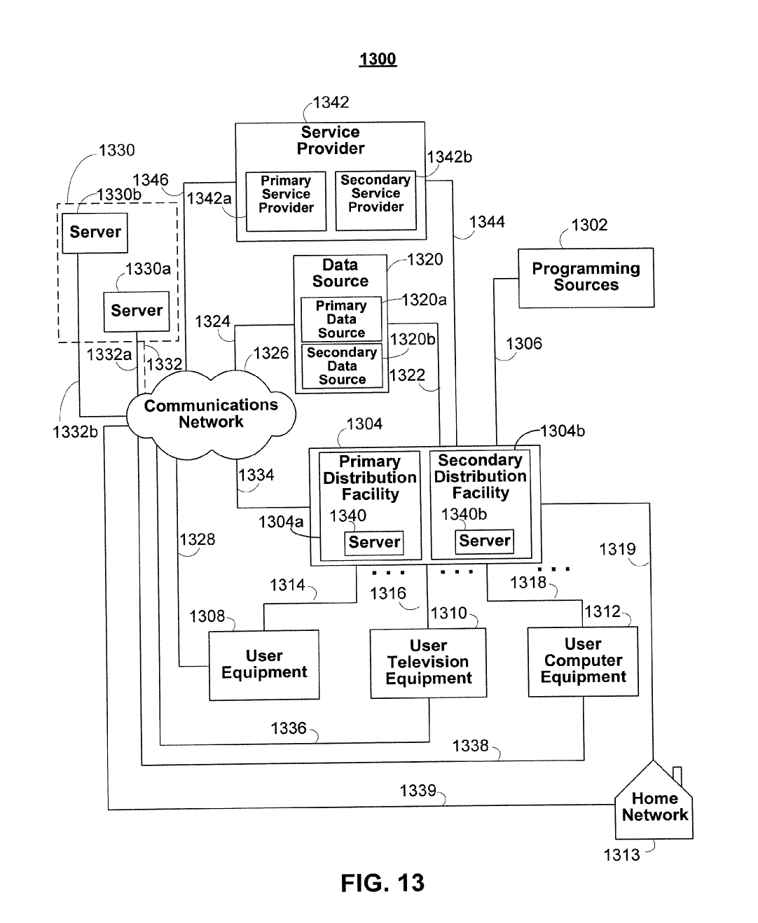

The media guidance application of the present invention may use application data to change its display screens and available options. Such application data may originate from computers located at one or more suitable facilities or locations (which are discussed below, for example, in connection with FIGS. 13-15). The following is a description of various media guidance application display screens, options and configurations related to search features in accordance with various embodiments of the present invention.

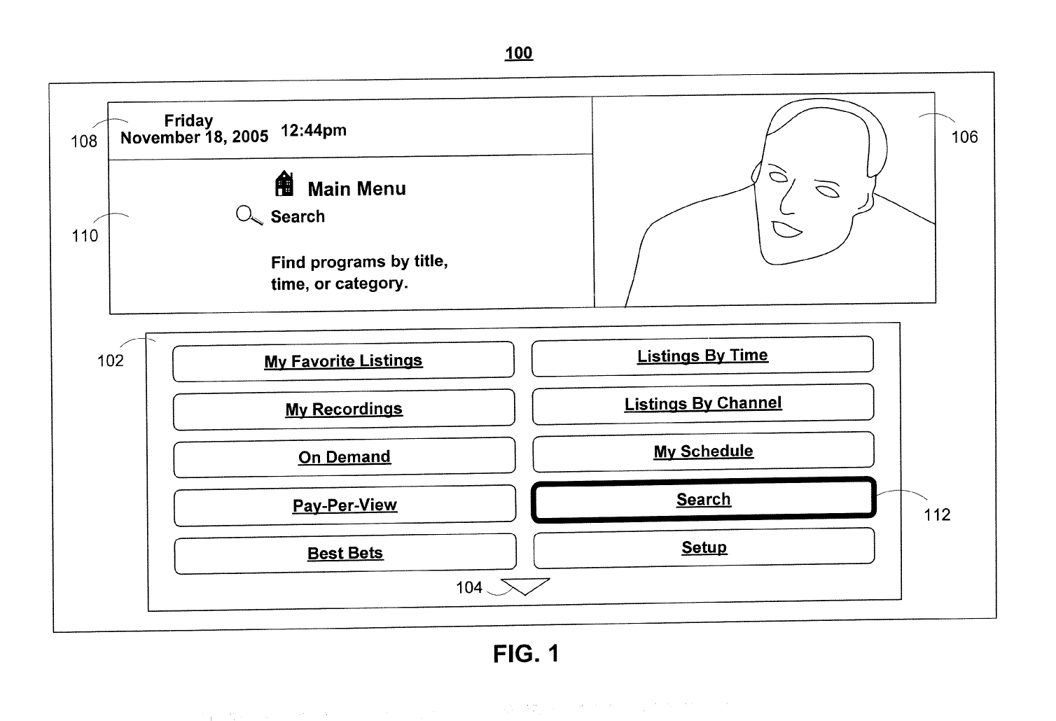

The media guidance application may display different interactive displays on a display screen. The displays provided by the media guidance application may utilize a portion of the display screen or the entire display screen. For example, FIG. 1 shows display 100. Display 100 is a main menu display that allows a user to access other interactive displays. The main menu display, as well as any other guidance application display, may be displayed in response to, for example, a user selection of a button from a remote control (which is discussed below, for example in connection with FIG. 19), a user selection of a button on user equipment, a voice recognition system recognizing a predetermined voice command (e.g., the user reciting the words “main menu”) or using any other suitable approach.

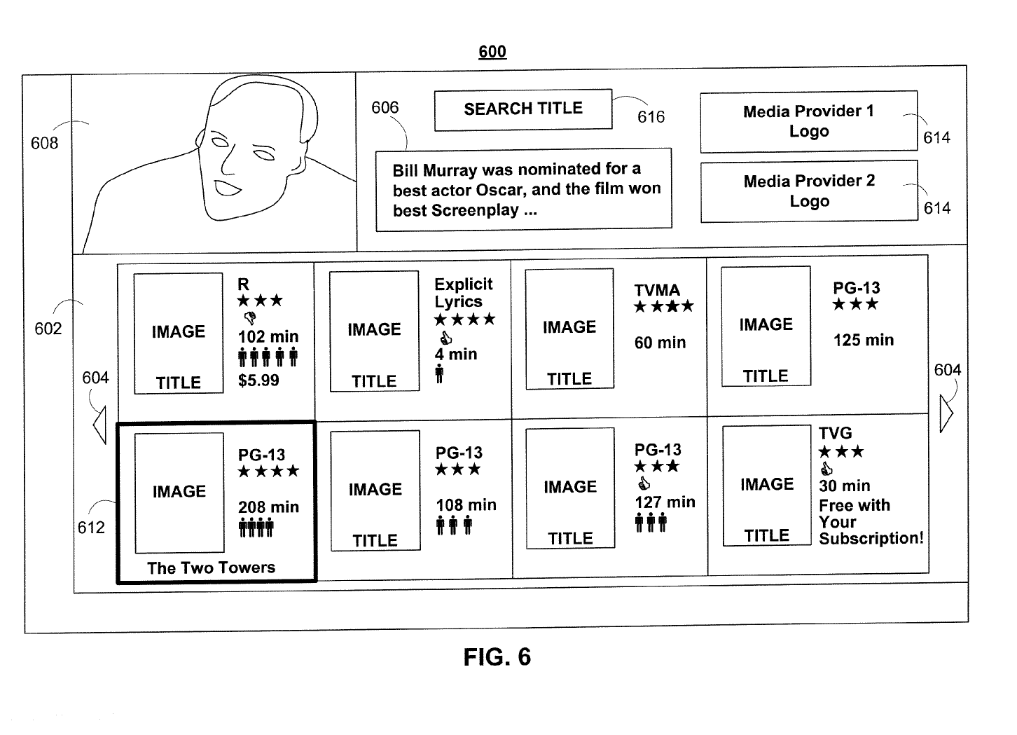

The main menu display of FIG. 1 includes options region 102. Options region 102 may allow the user to access different types of programs, media guidance application displays and/or media guidance application features. The user may access any feature or display by selecting any of the options (e.g., program listings, action icons, application feature listings, listings for other guidance application displays, etc.) displayed in region 102. Additional options may be displayed in response to the user selecting navigational icon 104. In some embodiments, the media guidance application may also hide one or more of the options currently displayed in response to receiving a user selection of navigational icon 104. (Pressing an arrow key on a remote control may effect the display in a similar manner as in navigational icon 104.) In some embodiments, main menu display 100, like any other display provided by an interactive media guidance application, may include one or more mosaic listings (which are discussed below, for example, in connection with FIGS. 6-9), for example, in options region 102 (not pictured).

In some embodiments of the present invention, navigational icon 104 is only displayed when at least one additional option is available. Although navigational icon 104 is pictured in FIG. 1 as a down arrow in options region 102, navigational icon 104 may be any suitable icon or text anywhere in any guidance application display. Similarly, a plurality of navigational icons may also be included in any given display or portion of a display.

Display 100, like any other media application display, may also include window 106. Window 106 may allow the user to preview and/or view any type of program that is currently available, was available or will be available to the user. The content of window 106 may correspond to or be independent from anything else displayed on the display screen.

The media guidance application may include area 108 in any of the displays provided to the user. Area 108 displays the current date and time and/or any other real-time information that may be of interest to the user. For example, area 108 may also indicate whether a particular user profile is active (not pictured) and/or user equipment status (not pictured). User equipment status may include, for example, whether the system is currently connected to the Internet, whether any peripheral devices are coupled to the user equipment, etc.

Instant info region 110 may also be included in any interactive media guidance application display. Instant info region 110 may provide textual information to the user. Images, icons and/or video may also be displayed in region 110. The content of region 110 may correspond to or be independent from the other portions of the display screen.

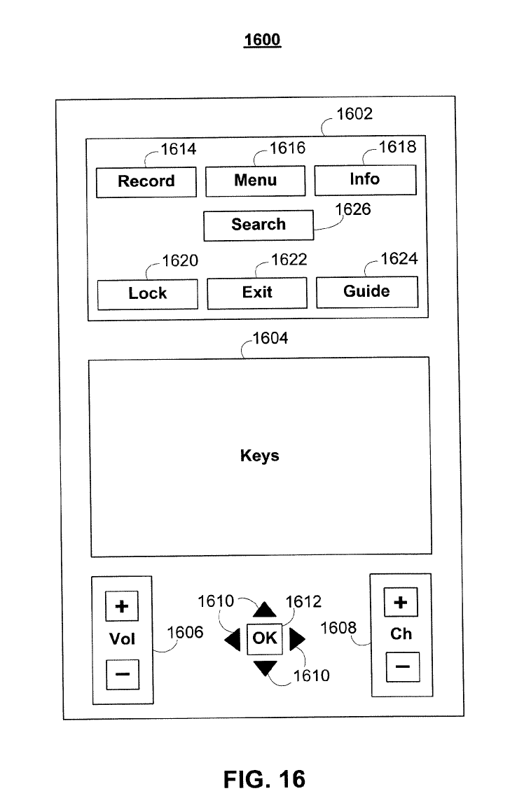

In FIG. 1, the information displayed in region 110 includes icons and text that correspond with the search option emphasized by highlight region 112. As described above, a user may move highlight region 112 over any of the options displayed in region 102. As highlight region 112 moves, the information in region 110 may change. The user may indicate a desire to select a highlighted option by, for example, pressing a remote control OK button (which is discussed below, for example in connection with FIG. 16).

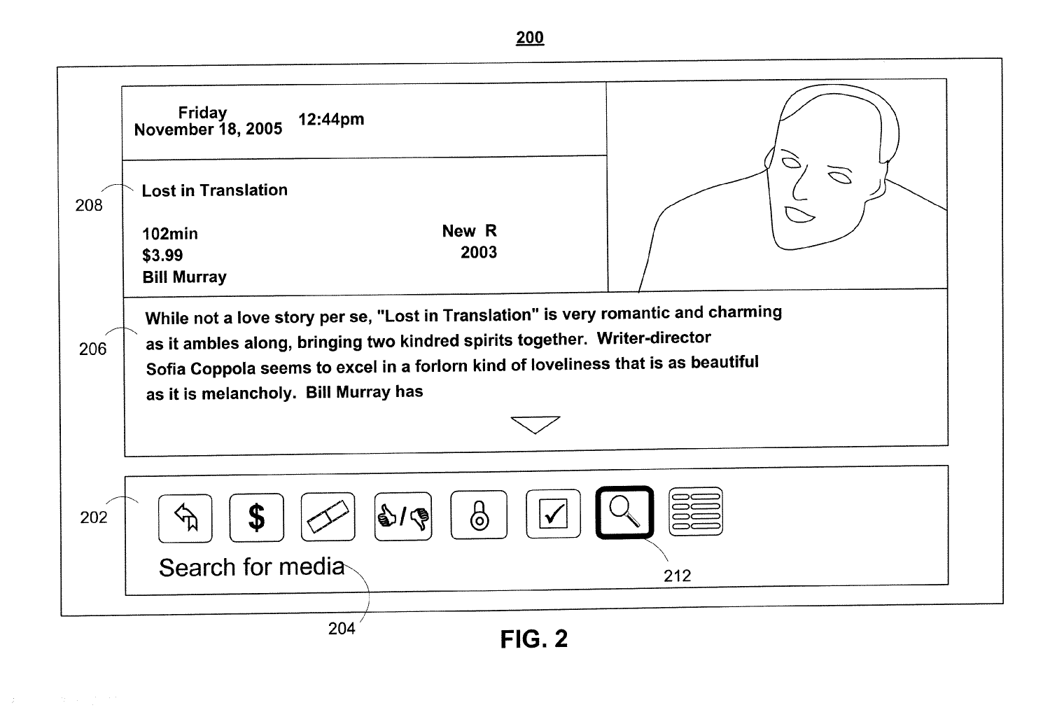

FIG. 2 shows illustrative display 200 that may provide, among other things, program information and media guidance features to the user. Display 200 includes options region 202, which is similar to options region 102. Options region 202 may also include text 204 that is not selectable. Text 204 corresponds to the icon that is currently highlighted by highlight region 212. (Highlight region 212, as well as every other highlight region mentioned herein, functions similarly to highlight region 112 described above in connection with FIG. 1.) Regions 206 and 208 display information about programs that are available to the user (e.g., information about the television program the user was viewing prior to entering the interactive display, information about programs the user may order via the interactive display, etc.). For example, region 206, as illustrated by FIG. 2, displays to the user a detailed summary of an available program and region 208 displays the user a brief summary.

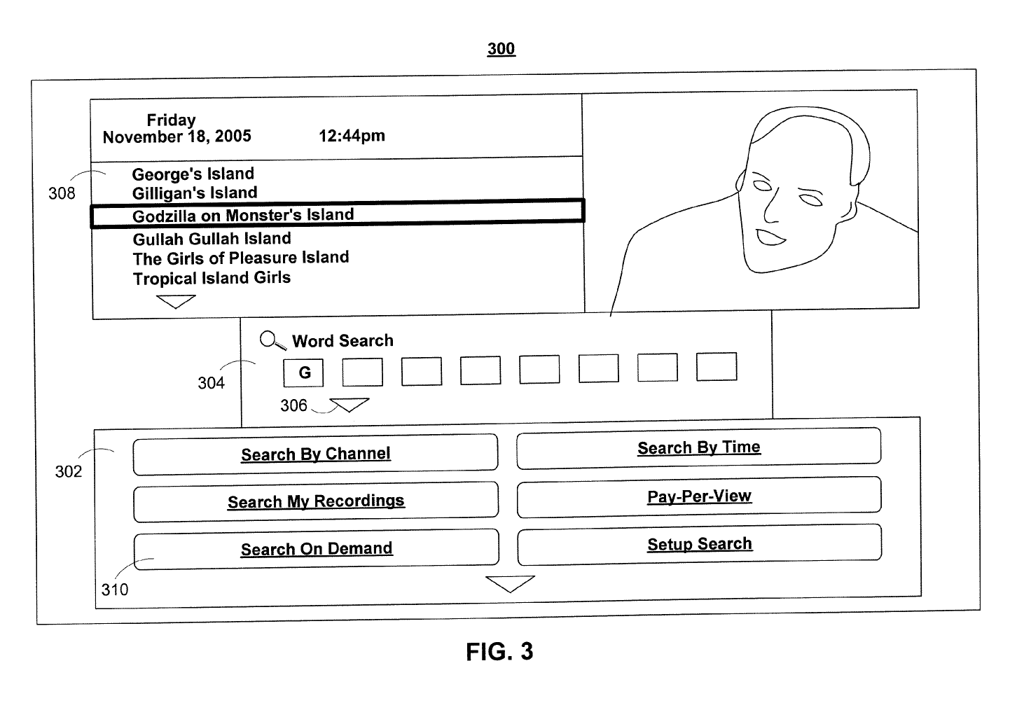

FIG. 3 shows illustrative display 300 that allows the user to configure a search or to access other search menus (e.g., for configuring a more detailed search, accessing saved searches, etc.). For example, the user may select one or more of the options displayed in region 302. Other options that may be included in region 302 include, for example, Search Music, Search by Day/Time, Search Pay-Per-View, Search by Media Provider, Search by Media Quality/Definition (e.g., standard definition, high definition, etc.), or any other means by which programs may be grouped, organized and/or searched. Search-related options as well as other application options are discussed, for example, by commonly-assigned Ellis et al., U.S. Provisional Patent Application No. 60/675,387, filed Apr. 27, 2005 (referred to herein as “the '387 application”), which is hereby incorporated by reference herein in its entirety.

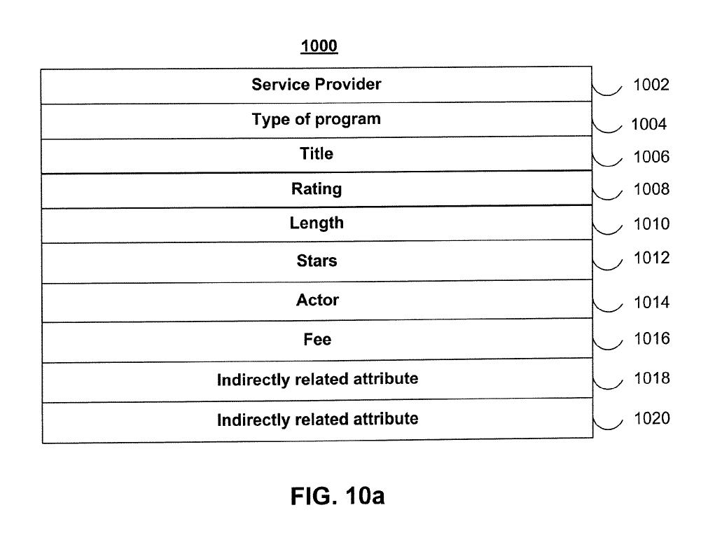

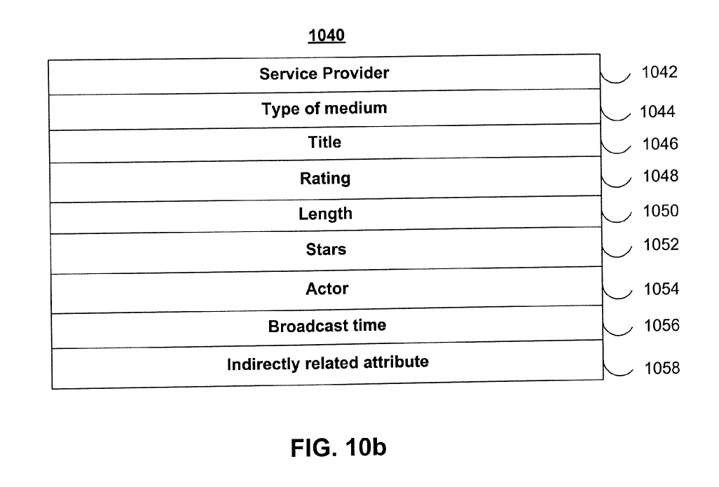

Character search region 304 may allow the user to search for programs based on one or more characters associated with one or more programs. For example, the system may find one or more characters that are part of any word (or text string) of an attribute that is associated with the program (e.g., title, description, director, actor, performer, etc.) by conducting a word search as shown in FIG. 3. Each program may have a data structure assigned to it that comprises fields for each of the attributes (as discussed below, for example, in connection with FIGS. 10a and 10b). Similarly, the media guidance application may only search for programs that have the characters, for example, in the title channel (e.g., HBO), website address (e.g., address that provides a program), or any other. The system may allow the user to change the character's association to the program (e.g., from “any word” to “title”) in response to the user selecting navigational icon 306. As another example, in response to receiving a user selection of navigational icon 306, the media guidance application may limit search results to programs that include the character(s) in the description (which would not include, for example, the program title) or any other attribute.

In FIG. 3, instant results region 308 provides the user program listings that match the user search criteria. The search results displayed in region 308 may update as the user configures or inputs the search or in response to the media guidance application receiving an indication that search is fully configured. Additional search features, displays, systems and methods are described in the '387 application.

In some embodiments, the media guidance application may display any portion of any display as one or more separate displays. For example, instant results region 308 may be displayed as a full screen display or an overlay that lists search results. Similarly portions of any display discussed herein may be combined with any other display or portions of any other display.

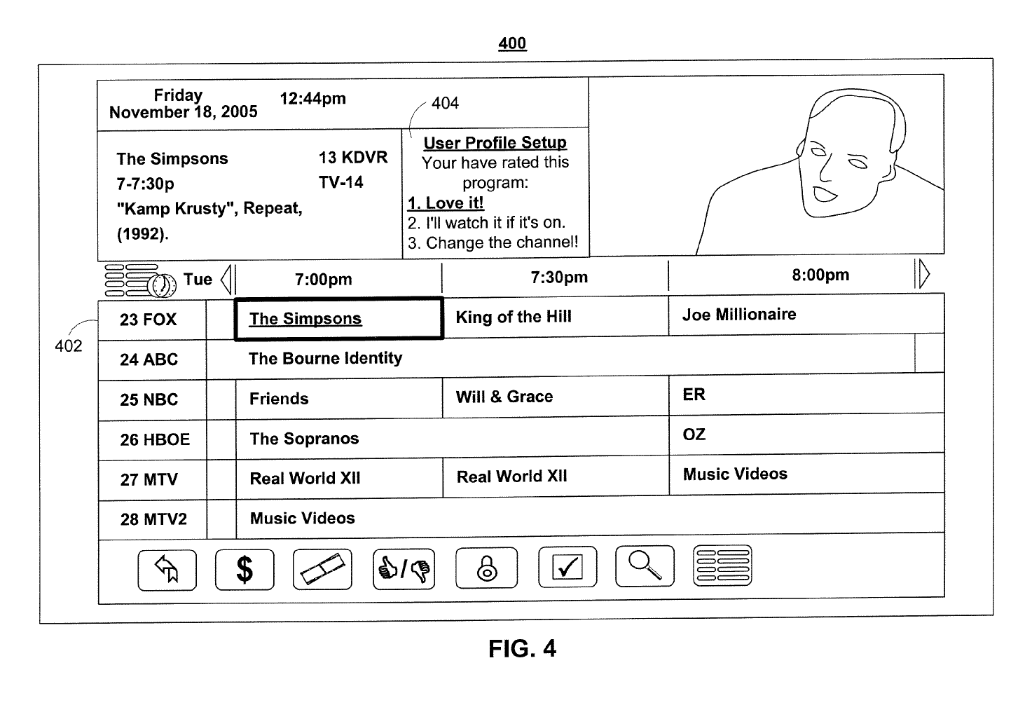

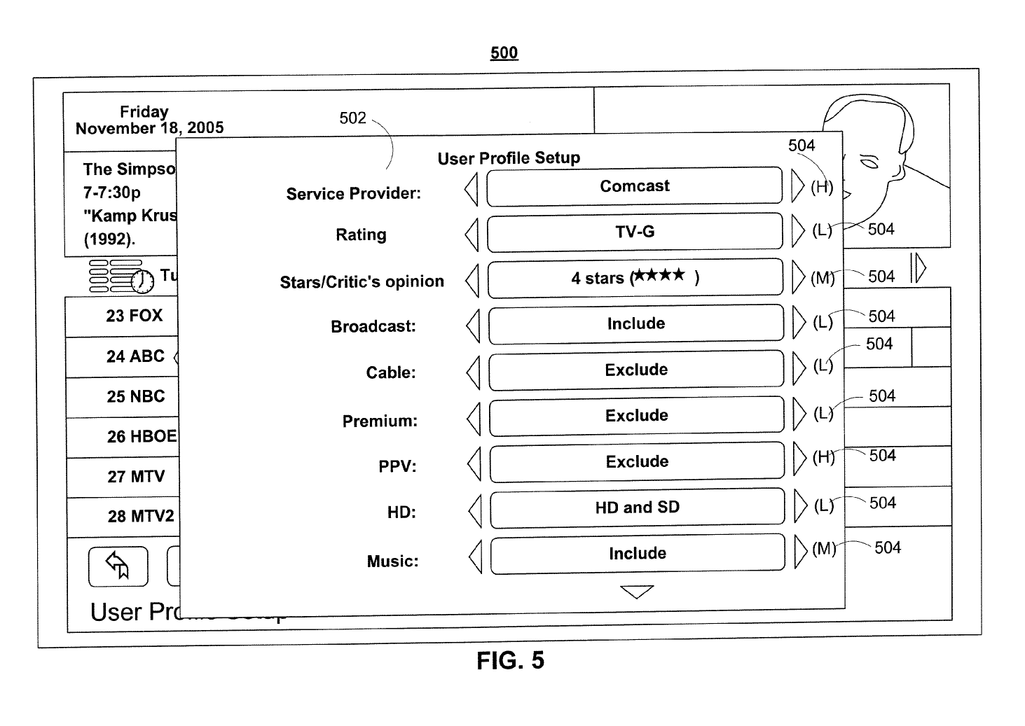

Some embodiments of the present invention may not require the user to enter as detailed of an initial search as described above. For example, the user may be able to simply select search on demand option 310 shown in region 302 of FIG. 3 and the media guidance application will generate additional search criteria based on a user profile (described below, for example, in connection with FIGS. 4 and 5). The media guidance application may then display, for example, search results of programs available on demand that match the user profile. Systems and methods for implementing and utilizing user profile options as well as systems and methods for accessing programs provided by different media providers are discussed, for example, by UV-344 Prov., Cordray et al., U.S. patent application Nos. 11/324,156 and 11/324,464, both filed Dec. 29, 2005 (attorney docket nos. UV-375A and UV-375B) (referred to herein after collectively as “UV-375”), and Cordray, U.S. patent application Ser. No. 11/324,183, filed Dec. 29, 2005 (attorney docket no. UV-378) (referred to herein after as “UV-378”). UV-375 and UV-378 are hereby incorporated by reference herein in their entireties.

The media guidance application may automatically compile the user profile. The media guidance application may, for example, monitor the programs the user accesses and/or any other interactions the user may have with the guidance application. Additionally, the media guidance application may obtain all or part of other user profiles that are related to a particular user (e.g., from the Internet, other media guidance applications, a handheld device, etc.), and/or obtain information about the user from any other source that the media guidance application may access. For example, a hotel may provide a media guidance application to its guests that may access the user profile stored on the user's media guidance application at home.

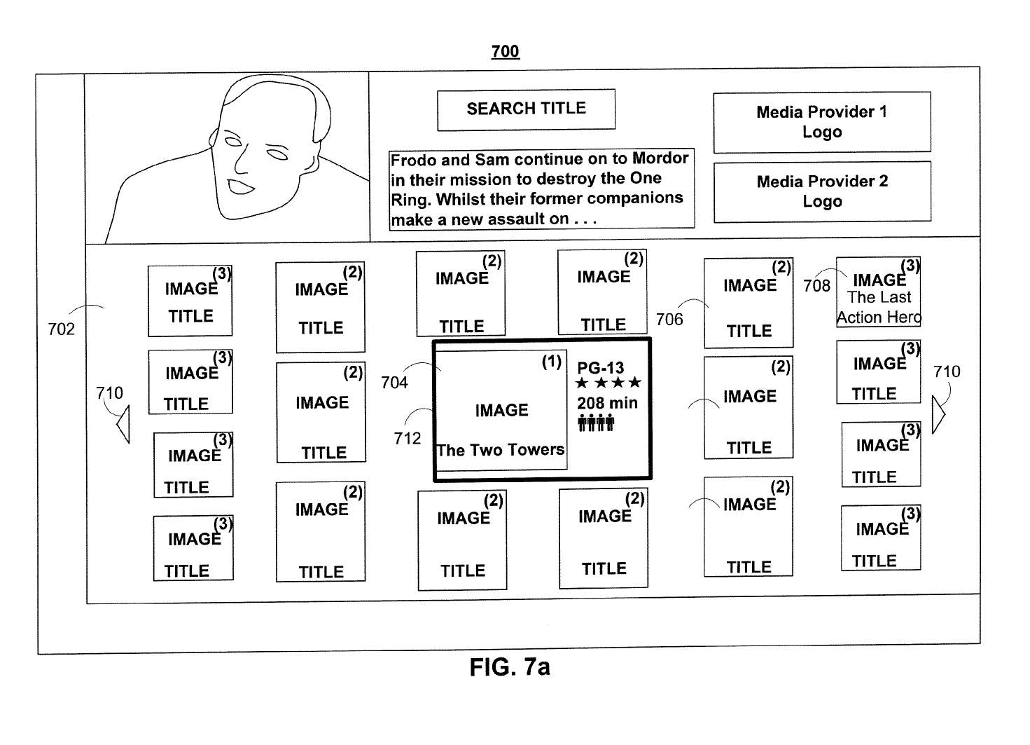

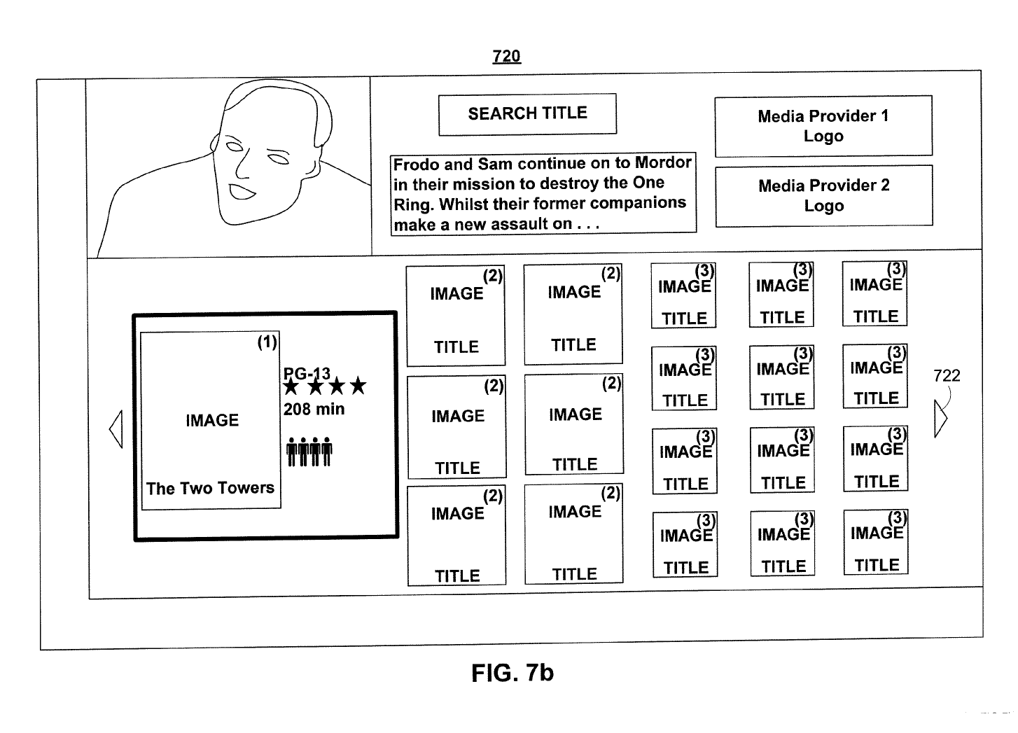

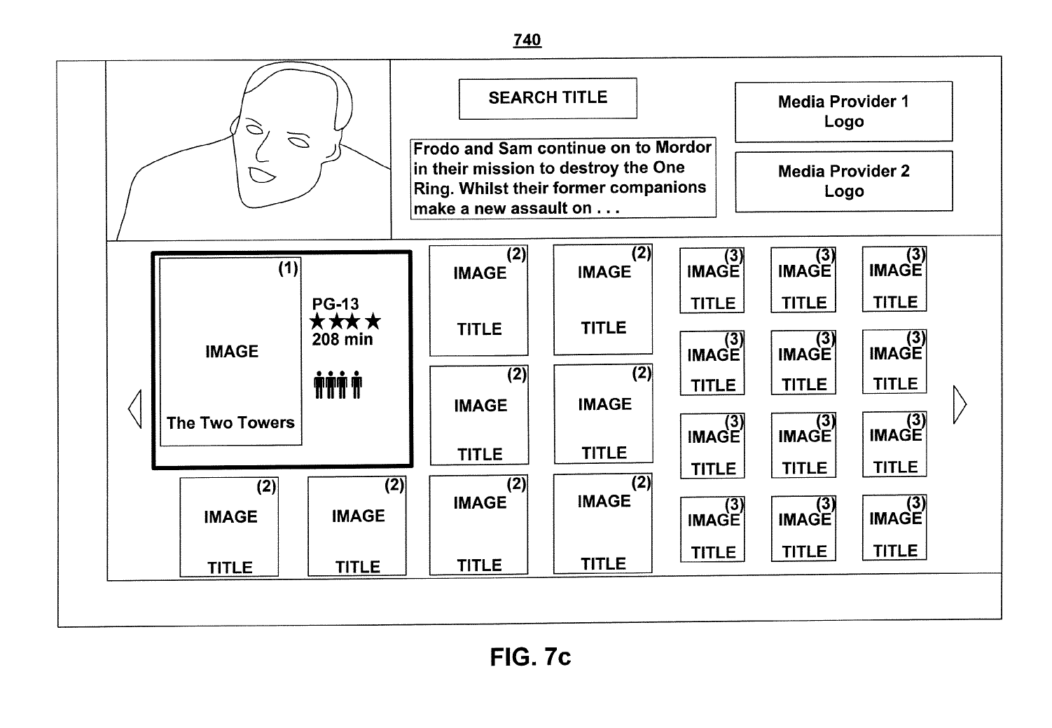

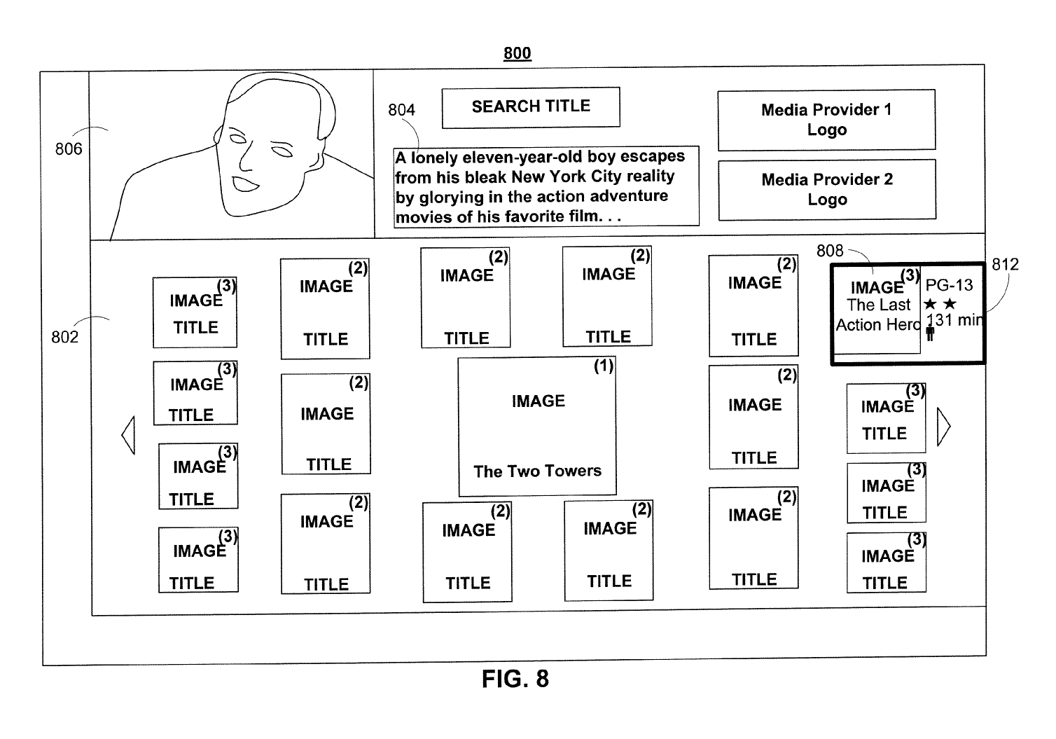

In some embodiments of the present invention, the media guidance application may provide the user with one or more displays that the user may use to create, setup, configure, save and/or access a user profile. FIG. 4 shows illustrative display 400 that may be used to configure, save and/or access the user profile. The interactive media guidance application may allow the user to navigate and select the program listings displayed in region 402. Information, video, images and/or icons associated with the selected program listing may be displayed to the user in region 110, region 108 and/or window 106. Region 404 may allow the user to configure a user profile by rating one or more programs. Other examples of how a user may evaluate programs is discussed, for example, in FIGS. 7 and 8 and in McKissick et al., U.S. patent application Ser. No. 09/356,245, filed Jul. 16, 1999, which is hereby incorporated herein by reference in its entirety.

The interactive media guidance application may then compare and contrast the attributes of the program(s) the user rated highly versus the attributes of the program(s) the user rated poorly. For example, when the user tends to rate action movies and rock music highly but romance movies poorly, the guidance application may associate action movies with the user profile. Likewise, the media guidance application may disassociate romance movies, broadcast programs, music, and all other programs that includes the attribute romance with the user profile based on the generally low user ratings for movies having the romance attribute. As the user rates more programs, the guidance application may be able to better determine the user's preference of programs. For example, even though the user does not like romance movies, the user may like romance music. As a result the user may rate romance music higher than romance movies. The guidance application may recognize this distinction and configure the user profile appropriately. Additionally, the user may associate entire sets search results with a user profile in a manner similar to how search results are associated with the moods described by the '387 application.

FIG. 5 shows illustrative program listings display 500 that may be used to configure a user profile. Display 500 includes region 502, which may allow the user to enter specific attributes the user would like to associate with the user profile. Similarly, region 502 may also allow the user to disassociate some program attributes with the user profile. In some embodiments, region 502 may also allow the user to rank one or more attributes by selecting and independently configuring icon 504 that corresponds with each attribute. The rank of each attribute (e.g., H—attribute is highly important, M—attribute is of medium importance, L—attribute is of low importance) may assist the media guidance application determine the relevancy of the search results (as described below, for example, in connection with FIGS. 6-9). The ranking based on low/medium/high importance is merely illustrative and any ranking approach may be utilized including, for example, providing a numerical rating (e.g., on a scale from 1-10), and ranking attributes as compared to each other (e.g., music is ranked 1, HD is ranked 2, cable is ranked 3, until the last attribute is ranked).

FIG. 6 shows illustrative display 600, which includes mosaic region 602. FIG. 6, like any other display provided by the media guidance application, may be the default display and/or the display initially provided by the media guidance application in response to the user indicating a desire to access the media guidance application. Mosaic region 602 includes one or more mosaic listings that, for example, are associated with search results. When the mosaic listings are associated with search results, the mosaic listings may be arranged in a graphical manner to emphasize the relative degree of relevancy to the search criteria. The search results may be associated with on program(s) that match the search criteria entered by the user and/or generated by the media guidance application. When the mosaic listings are not associated with search results, the mosaic listings may be arranged in a graphical manner to emphasize the relative degree of importance to the user. Each of the mosaic listings may be any image including, for example, box art of movies, cover art of compact discs, user generated images, clipart (downloaded or user created), a logo associated with the program and/or any other picture or video associated with the program (e.g., the image may be the video of the program or a frozen frame of the program).

In addition to or in place of the images displayed with each mosaic listing in mosaic region 602, the media guidance application may display the rating (e.g., critic's rating, user's rating, governing entity's rating, etc.), length, price, title, type (e.g., movie, broadcast program, recorded program, music, etc.) and/or any other characteristic(s) associated with the program. These characteristics may help the user select a search result. Additional more detailed information, previews and/or any other data associated with any of the search results may also be displayed by the media guidance application in region 606 (which may have similar functionality as region 206 discussed above), window 608 (which may have similar functionality as window 106 discussed above), in a pop-up window (not pictured) and/or in any other display. This other data may be presented to the user in response to the user indicating a desire to access such data.

The media guidance application may provide sound to the user. In some embodiments, the sound may correspond with the program (or image associated with the program) being displayed in window 608. For example, when an image associated with a music program is being displayed in window 608, the sound associated with the music program may also be provided to the user. In other embodiments, the sound may correspond with the program associated with the mosaic listing surrounded by highlight region 612. For example, the user may move highlight region 612 to surround a new mosaic listing and, in response to highlight region 612 being moved, the sound provided by the media guidance application may correspond with the program associated with the new mosaic listing. As another example, the sound provided by the media guidance application may not change after moving highlight region 612 until the user independently indicates that the user would like the sound to correspond with the program associated with the new mosaic listing (e.g., by selecting the mosaic listing, pressing a button on the remote control, etc.). In yet other embodiments, the sound may correspond to a pop-up window (such as, for example, the pop-up window mentioned above that is not pictured).

As indicated by the inclusion of highlight region 612, mosaic listings may be selectable. The media guidance application may allow the user to navigate the search results. As the user moves highlight region 612, as described above, the video/image displayed in window 608 and/or the information displayed in region 606 may change. Alternatively, the video/image shown in window 608 may only change when the media guidance application receives a user request to preview a given search result. In yet other embodiments, the video/image displayed in window 608 and/or the information provided in region 606 may correspond to the program the user was previously watching (and/or listening to) prior to entering the guide and/or display 600. In some embodiments, the information provided in region 606 may correspond with the video/image displayed in window 608.

One or more media provider logo(s) 614 may be displayed by the media guidance application. Logo(s) 614 are associated with the media provider(s) that provide the currently displayed search results. In some embodiments the media guidance application may return search results provided by more than one media provider.

When the user selects navigational icon 604 pictured in display 600, at least one new search result would replace at least one of the search results currently displayed. This may affect which media provider logo(s) 614 are displayed to the user. Alternatively, the number and which media provider logo(s) are displayed may be associated with all of the search results, regardless of which subset of the search results are currently being displayed (as opposed to the search results that are not currently displayed but are displayed in response to the user selecting navigational icons 604). The media guidance application may allow the user to select media provider logo(s) 614, which indicates to the media guidance application that the user would like to refine the search results based on the media provider (e.g., only display search results provided by the media provider associated with the user selected media provider logo(s) 614).

In some embodiments of the present invention, display 600 may include search results that match a saved search (or any other search that has been given a title). A saved search is a set of search criteria that was previously saved, either by the user or by the guidance application. The search results may be displayed in response to the user indicating a desire to execute the search. The title of the search may be displayed in region 616 to remind the user which saved search the currently displayed search results correspond with. Additional features associated with saved searches are discussed in the '387 application.

In some embodiments of the present invention, the media guidance application may present equally-sized mosaic listings in mosaic region 602 (as shown in FIG. 6) regardless of the degree in which the search results match the search criteria. In other embodiments, the media guidance application may associate the search results with one or more levels of relevancy. The media guidance application may base a particular program's relevancy on how similar the program is to the search criteria (e.g., a program's relevancy is directly correlated to how similar the program's attributes are to the search criteria). When the media guidance application is configured to display search results in levels of relevancy, mosaic region 602 (having equally sized mosaic listings) may be generated when all of the displayed search results are equally relevant.

In some embodiments, in addition to being associated with search results, the mosaic listings included in region 602 may be associated with media guidance application features, programs that are not search results and/or non-media guidance application features. This may allow the media guidance application to suggest features, programs and/or other applications (including non-media guidance applications) to the user. For example, mosaic region 602 may function as a niche hub that allows the user to access different media guidance application features. Niche hubs are discussed, for example, in commonly-assigned U.S. patent application Ser. No. 09/604,470, filed Jun. 26, 2000, which is hereby incorporated by reference in its entirety. In some embodiments, the user may configure what is associated with the mosaic listings. The media guidance application may also determine what is associated with the mosaic listings (e.g., based on a user profile or information the media guidance application receives from its provider).

FIG. 7a shows illustrative display 700 that provides search results to the user that are arranged in a graphical manner to emphasize three levels of relevancy to the search criteria. Each level of relevancy is graphically distinguished to indicate how well the search results of each level match the search criteria. Level 1 (i.e., the most relevant search result(s)) is surrounded by level 2. The level 1 search result (e.g., mosaic listing 704) is displayed in a manner that indicates to the user that the search result has the highest correlation to the search criteria (e.g., the largest mosaic listing centered among the other, smaller mosaic listings). The smallest mosaic listings (e.g., mosaic listings 708) displayed in mosaic display 702, that are the farthest from level 1, comprise level 3. Level 3 represents the least relevant search results currently being displayed by the media guidance application. Level 2 is displayed between level 1 and level 3 and includes search results (e.g., mosaic listings 706) that are less relevant than level 1 but more relevant than level 3. Level 3 is less relevant because in relation to the other levels of search results, level 3 is least similar to the search criteria.

Although display 700 only includes three levels of relevancy, one skilled in the art would understand that more or less levels may be used to distinguish the search results' different degrees of relevancy. One skilled in the art would also appreciate that the particular search inputted or processed may dictate how many levels are displayed and how many search results are displayed in each level. For example, a plurality of level 1 search results may be displayed by the interactive media guidance application. As another example, some search results displayed by the media guidance application may include only a single search result that displayed as a level 2 or level 3 search result. As yet another example, in some embodiments the media guidance application may not include an entire level of search results among the displayed search results (e.g., search results may be displayed that do not include any level 1 search results).

The graphical organization of the levels is not limited to decreasing the level of relevancy radially outward from the center of mosaic display 702. In some embodiments, as shown by display 720 of FIG. 7b, the level of relevancy may decrease from left to right. In yet other embodiments, the level of relevancy may decrease from left to right and top to bottom as in display 740 of FIG. 7c. It will be appreciated that levels of relevancy can be shown in any other direction (e.g., right to left, bottom to top, etc.). However, display 700, display 720 of FIG. 7b and display 740 of FIG. 7c are only meant to be exemplarily illustrations of the present invention and not limiting. Other graphical indicators (such as the numbers in parenthesis associated with each mosaic listing in region 702) would be apparent to one skilled in the art and may be displayed to further distinguish the levels in a graphical manner without departing from the spirit of the invention. Additional ways of distinguishing the levels that are not pictured may include, for example, color coordinating the levels, a three dimensional display where the mosaic listings have varying amounts of depth, other graphical organizational schemes, displaying different amounts of information based on the different levels, etc. Moreover, the media guidance application may be pre-configured to display the relevancy of levels in a particular manner, allow the user to choose which display the user prefers, and/or allow the user to configure additional displays.

Additional search results that are equally or less relevant than the search results displayed in region 702 may be displayed in response to the user selecting navigational icon 710. This may cause the media guidance application to update the display, for example, to include only search results of level 3 (e.g., in response to the at least one selection of navigational icon 604). When only level 3 search results are displayed, the relative size of the mosaic listings may change (e.g., the level 3 mosaic listings may become larger when the media guidance application is not currently displaying any level 1 and/or 2 search results). For example, from display 720 if the user selects navigational icon 722 the resulting display may be similar to FIG. 6, except for the mosaic listing for The Two Towers would not be displayed (because the user navigated away from that mosaic listing by selecting navigational icon 722). In another example, when mosaic listings of level 4 are displayed (not pictured) with mosaic listings of level 3 (and without any mosaic listings of level 1 or 2), the level 3 listings may be displayed similar to the mosaic listings of level 1 (e.g., mosaic listing 704 surrounded by highlight region 712) in relation to the mosaic listings of level 2 (e.g., mosaic listing 706). In this way, programs corresponding to a mosaic listing may be promoted (i.e., the level of relevancy may be raised).

FIG. 8 shows illustrative display 800 that that provides search results to the user that are arranged in a graphical manner to emphasize different levels of relevancy. Display 800 includes highlight region 812, which surrounds level 3 mosaic listing 808. Because highlight region 812 is surrounding mosaic listing 808, the media guidance application provides, for example, ratings information, title and the length of the program to the user (e.g., in highlight region 812). Additionally, more detailed information may be displayed in region 804 and video/image associated with the program may be displayed in window 806. Mosaic listing 812 may also increase in size and the mosaic listing navigated from may also decrease in size.

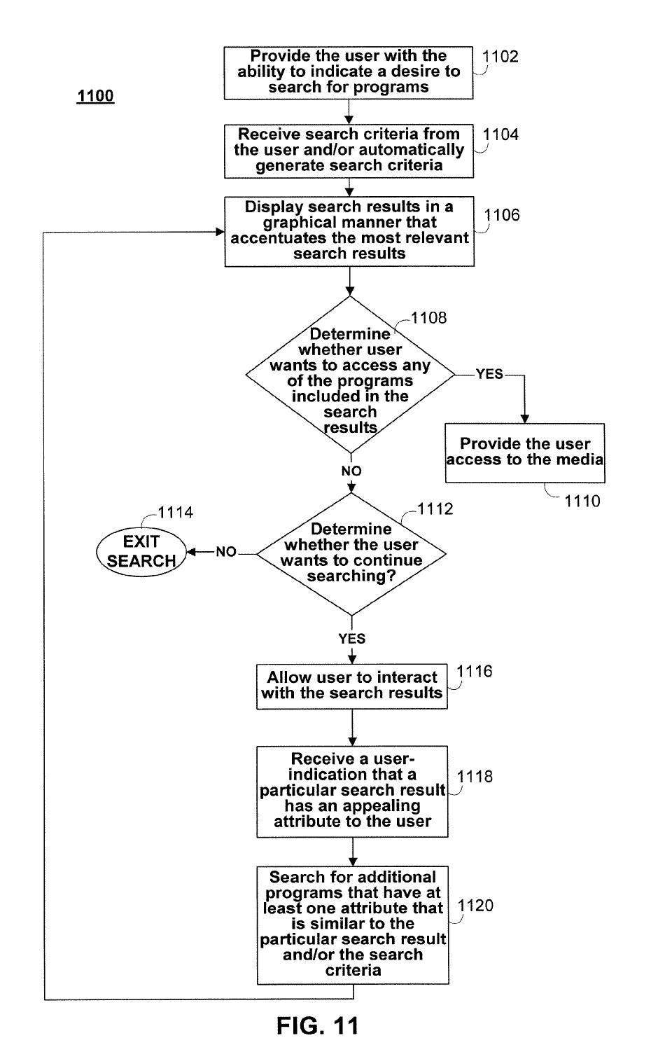

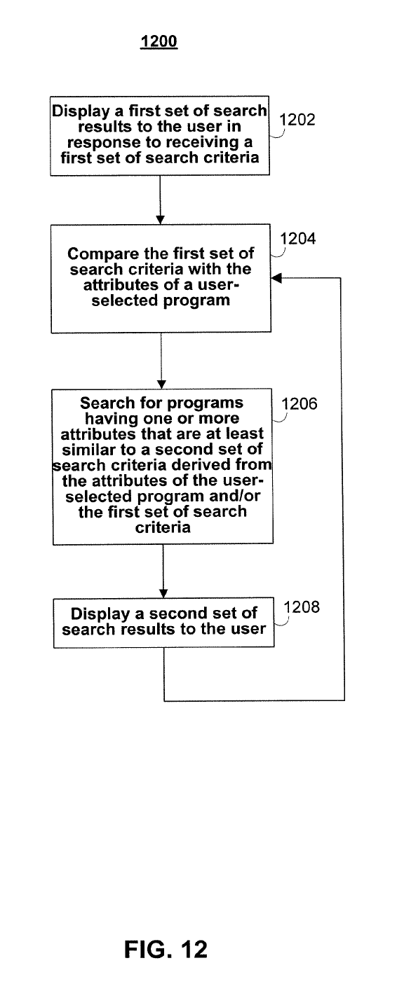

The media guidance application may compile new search criteria after comparing the attributes of the previous search criteria with the attributes of one or more programs identified as being of interest to the user. (See below, for example, in connection with FIGS. 11-12 for a description of compiling new search criteria.) The one or more programs may be selected by the user from the search results of the previous search (such as the programs corresponding with the mosaic listings of FIG. 8). For example, the user may move highlight region 812 so that it surrounds mosaic listing 808 (as shown in FIG. 8). The attributes of the program associated with mosaic listing 808 may be added to the previous search criteria, creating the new search criteria, in response to the user selecting a search button, OK button, or other button on a remote control and/or by any other user interface. In some embodiments, options may be provided to the user via a pop-up menu (not pictured) that is associated with highlighted program.

In some instances, the program's attributes may conflict with the previous search criteria. For example, the previous search criteria may limit search results to PG-13 or less (e.g., a G-rated program may be considered a program rated less than PG). Programs that do not match all of the search criteria, however, may be displayed as less relevant search results (i.e., less relevant than, for example, those programs that match more of the search criteria and/or those programs that match the higher priority attributes of the search criteria). For example, when a search is conducted based on the previous search criteria, an R rated program may be displayed as a level 3 search result because the corresponding program matches other attributes of the previous search criteria aside from being R-rated.

The media guidance application may automatically or be user configured to resolve such conflicts between the attributes of the previous search criteria and the attributes of the selected program. For example, in some embodiments of the present invention, the media guidance application may generate new search criteria by supplementing the previous search criteria to include programs rated R or less. As another example, the media guidance application may generate new search criteria wherein the rating attribute “R” replaces “PG-13 or less”. In yet other embodiments, the media guidance application may ignore the fact that the selected program is rated R and continue to display programs rated PG-13 or less as more relevant. Alternatively, if a rating preference was not included in the previous search criteria, the media guidance application may generate new search criteria by supplementing the previous search criteria to include R rated programs. One skilled in the art would understand that such conflict resolution features may be applied generally to any attribute and are not restricted to the program's rating.

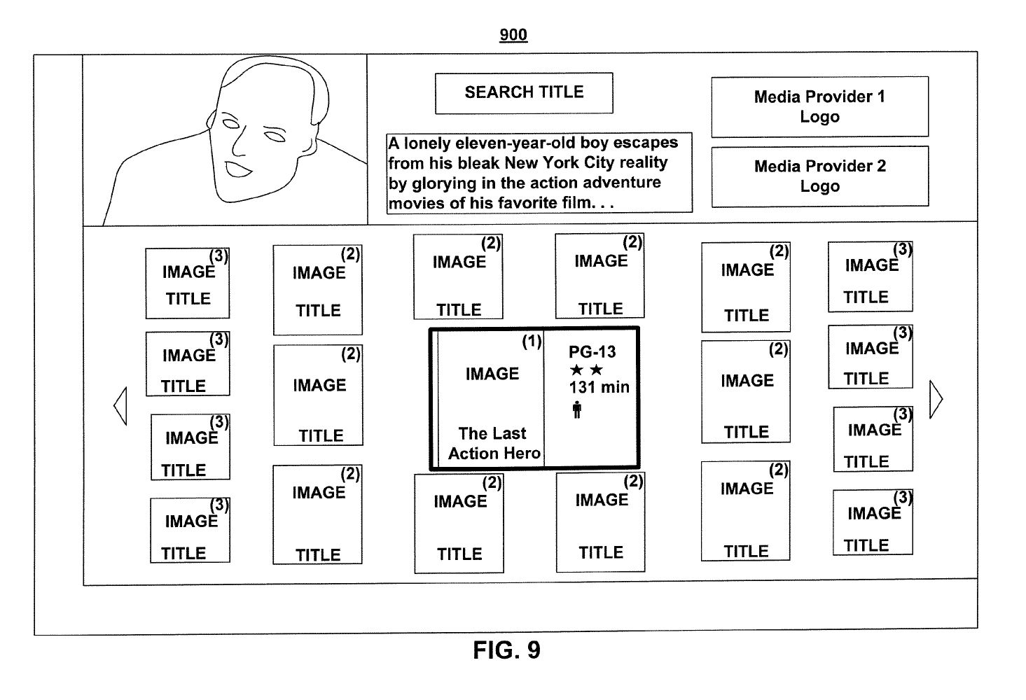

FIG. 9 shows illustrative display 900 of a second set of search results arranged in a graphical manner to emphasize the levels of relevancy to the search criteria. Display 900 may be the search results displayed after conducting a new search based on new search criteria in response to the interactive media guidance application receiving a user selection of mosaic listing 808. In some embodiments, any program that was displayed in the first set of search results may not be displayed again as a new search result because the guidance application may interpret the user not selecting to access a program as an indication the user is not interested in accessing the program. In other embodiments, because a program was not selected, its level of relevancy may decrease and may be displayed in a less prominent position of a display.

The following is an illustrative example of the operation of the present invention and is not meant to limit the invention. In this example, the user may initially configure the search criteria to include: 1) programs that are movies on demand; 2) action programs; 3) science fiction programs; 4) programs released after 1995; and 5) programs rated PG-13 or less. In some embodiments, the numbers 1-5) may indicate the priority of each attribute of the search criteria. The priority of the attributes may be user-configured, automatically generated or hybrid of the two (e.g., based on the user profile which was discussed above, for example, in connection with FIGS. 4-5). In some embodiments, the user entered search criteria may be supplemented with the user's profile. As a result of the search criteria, “The Lord of the Rings The Two Towers” is displayed as the most relevant search result (i.e., as a level 1 search result (as shown by FIGS. 7a, 7b and 7c)). “The Last Action Hero,” among other movies, satisfies the other search requirements and is also displayed as a less relevant search result. “The Last Action Hero” is displayed as a search result because “The Last Action Hero's” attributes indicate that it is: 1) a movie available on demand; 2) an action program; 3) a science fiction program; 4) a program released after 1995; 5) a program rated PG-13; and 6) a program that includes Ian McKellen as an actor common to both movies.

Despite the similarities, “The Last Action Hero” is a level 3 search result initially because there are other movies available on demand that are more closely related to the search criteria. “The Last Action Hero” may also not match the user profile. For example, “The Last Action Hero” only received two stars, but the media guidance application may have detected (based on past user activity or user input) that the user only watches movies On Demand that have 4 or more stars.

Even though R rated movies were explicitly prohibited by the user, mosaic listing 808 displayed for “The Last Action Hero” may remind the user of the R rated Arnold Schwarzenegger movies that the user would like to access. This is a logical progression because the attributes of many Arnold Schwarzenegger movies meet the first four out of five user configured search criteria that were mentioned above. The user may then move highlight region 812 and select mosaic listing 808 (which is associated with “The Last Action Hero”). The user may select the mosaic listing, not necessarily because the user wants to watch “The Last Action Hero,” but rather because it has an appealing attribute, e.g., Arnold Schwarzenegger. The media guidance application may then compare the search criteria with the attributes of “The Last Action Hero” and generate a second set of search results (as shown in FIG. 9).

When the next set of search results are displayed, “The Last Action Hero” is now a level 1 search result. The other search results displayed may include Arnold Schwarzenegger movies, available on demand that were awarded 4 stars, were classified as action and science fiction and were released after 1995. However, most of the programs that have those attributes are rated R. As a result the user is provided movies that are rated R as well. As mentioned above, the second set of search results may not include any search result displayed in the first set of search results.

The content and/or portions included in the display screens illustrated by FIGS. 1-9 may also be accessed in a browse display window overlaid on a portion of the display screen. Browse displays may allow users to view and navigate through portions of display screens of FIGS. 1-9, while viewing other media content on the display screen. Browse display windows are described in more detail in Reynolds et al. U.S. Pat. No. 6,563,515 issued May 13, 2003, which is hereby incorporated in its entirety.

The media guidance application displays shown in FIGS. 1-9 utilize commonly-used guidance application selection objects. It will be understood that these selection objects are only illustrative, and other selection objects, such as hyperlinks, buttons, lists, dropdown boxes, checkboxes, and radio buttons can be used by those skilled in the art without departing from the scope and spirit of the present invention.

The media guidance application may associate a data structure with each program. FIG. 10a and FIG. 10b illustrate data structure 1000 and data structure 1040, respectively. Data structure 1000 may represent a different type of program than the type of program represented by data structure 1040. For example, data structure 1000 is for a pay program (e.g., Video on demand, music file, etc.) and, therefore, includes fee field 1016 (but does not include a field for a broadcast time because video on demand or a music file are available at all times). As another example, data structure 1040 is for a broadcast program and, therefore, includes broadcast time field 1056 (but does not include a field for a fee because most broadcast programs are included with a subscription and do not require an access fee to be paid). As another example (not pictured), a data structure for a Pay-Per-View program may include both a fee field and a broadcast time field.

Each field of the data structure may contain a searchable attribute. One or more fields may be a higher priority than other fields of the same data structure. Some fields may be common to all data structures. For example, both data structures have a field dedicated to the following program attributes: service provider (i.e., field 1002 and field 1042), the type of program (i.e., field 1004 and field 1044) (e.g., music, broadcast program, Video on demand, recorded program, etc.), title (i.e., field 1006 and field 1046), rating (i.e., field 1008 and 1048), length (i.e., field 1010 and 1050), rating (i.e., field 1012 and field 1052) and actor (i.e., field 1014 and field 1054). In addition to common fields, each program may have fields that are unique to the particular program.

Each attribute and/or field may be given a level of priority. The priority of the attribute and/or field may assist the media guidance application in determining the level of relevancy of a search result. Priority attributes is described in greater detail herein, for example, in connection with FIG. 5.

In some embodiments, the program's data structure may also include at least one field dedicated to attributes that are indirectly related to the program. FIG. 10a, for example, includes field 1018 and field 1020 to illustrate a plurality of fields dedicated to attributes that are indirectly related to the program. It will be appreciated that other attributes may have a plurality of fields associated with the attribute (e.g., fields 1014, 1054, 1056, etc.). FIG. 10b includes field 1058 to illustrate a field dedicated to an attribute that is indirectly related to the program. For example, recently a lot of press has been directed to Tom Cruise's association with the religion of Scientology and the actress Katie Holmes. As a result, Scientology and Katie Holmes may be indirectly related attributes of programs that include Tom Cruise as one of the directly related attributes. Moreover, indirectly related attributes, unlike directly related attributes (e.g., actor, title, description, etc.) may change over time. For example, five years ago programs associated with Tom Cruise may have also been associated with the actress (and Tom Cruise's ex-wife) Nicole Kidman.

Indirectly and directly related attributes may be ranked in order (be assigned relevant priorities) to determine various levels of relevance. For example, Katie Holmes may be ranked higher than Nicole Kidman as an indirect attribute of Tom Cruise's programs because of its time relevancy. As a result programs with Katie Holmes may be given a level 1 relevance whereas programs with Nicole Kidman may be given a level 3 relevancy when displayed in any of the displays of FIGS. 7-9.

Any of the fields of data structure 1000 and/or data structure 1040 may have identifiers associated with the fields. Any of the fields may also be organized as a linked list, an array, a table, and/or any other organization scheme used to store data. Moreover, data structure 1000 and/or data structure 1040 may include an additional field (not pictured) that includes a data structure identifier or program identifier. This additional field may allow multiple data structures to be linked together (including to each other). It will be appreciated that all the fields in the data structures and the data structures themselves may be organized using any organization scheme.

FIG. 11 shows an illustrative flow diagram 1100 that provides the user with the ability to indicate a desire to search for programs. The media guidance application allows for the user to initiate a search at step 1102. At step 1104, the media guidance application compiles the search criteria that is received from the user and/or automatically generated by the media guidance application (as described above, for example, in connection with FIGS. 3-6). At step 1106 the search results are displayed in a graphical manner that accentuates the most relevant search results (as described above, for example, in connection with FIGS. 6-9). At step 1108, the media guidance application determines whether the user wants to access any of the search results. When the user indicates that the user has located a program the user would like to access, the program is provided to the user at step 1110. When the programs included in the search results does not satisfy the user, the media guidance application determines whether the user would like to continue searching for additional programs at step 1112. When the media guidance application receives an indication that the user does not wish to continue searching, the media guidance application exits the search at step 1114. The media guidance application may, for example, display the program the user was viewing prior to entering the search mode.

When the media guidance application receives an indication that the user would like to continue searching, the media guidance application allows the user to interact with the search results at step 1116 (as described above in connection with FIGS. 7-9). At step 1118, the media guidance application receives a user-indication that a particular media has an attribute that is appealing to the user. At step 1120 the media guidance application searches for additional programs that has at least one attribute that is similar to the particular program and/or the search criteria. The media guidance application then displays the second set of search results to the user in a manner that accentuates the most relevant search results (as described above).

FIG. 12 illustrates a flow diagram 1200. Flow diagram 1200 is directed to the steps the media guidance application may utilize when refining a set of search results. At step 1202 a first set of search results is displayed to the user. Step 1202 may correspond with, for example, steps 1102-1106 as described above in connection with FIG. 11.

At step 1204, the media guidance application may compare the attributes of the first set of search criteria with the attributes of a user-selected program, wherein the program was selected from the first set of search results (as discussed above, for example, in connection with FIGS. 6, 7a, 8 and 9). In some instances, the media guidance application may determine that the selected program has an attribute that conflicts with (i.e., differs from) an attribute of the search criteria. The media guidance application may make the determination by comparing the attributes of the selected program found in the fields of the program's data structure (as discussed above, for example, in connection with FIGS. 9-10) with the attributes of the initial search criteria.

As an example, the selected program may be rated R, but the search criteria may have been configured to only include programs rated PG or less. In some embodiments, the media guidance application may simply substitute the search criteria to include programs that have the attribute of the user-selected program (e.g., that are rated R) when the search is conducted in step 1206. In other embodiments, the media guidance application may supplement the search criteria with the attribute of the user-selected program, thereby searching for programs in step 1206 having either value for the attribute with a conflict (e.g., programs rated R or PG are searched for). In yet other embodiments, the media guidance application may not modify the attribute with a conflict when generating the second set of search criteria discussed in step 1206 (e.g., when searching for R rated programs violates a user profile that is parentally controlled). At step 1208, the second set of search results is displayed.

The phrase “first set of search results” is not intended to suggest that step 1202 is limited to the initial set of search results. The phrase is merely meant as a point of reference for differentiating the search results. Moreover, in some embodiments, the user may want to continue searching and select a search result included in the second set of search results. This causes the media guidance application to return to step 1204, wherein the “second set of search results” of step 1208 is now the “first set of search results” referred to in step 1204.

The interactive media guidance application (described above in connection with, for example, FIGS. 1-12) may search for programs provided by, for example, the Internet, mobile computing and high-speed wireless networks, personal computers (PCs) and/or devices on which they traditionally could not. Non-television-centric platforms (i.e., platforms that distribute programs with equipment not part of the user's broadcast, cable or satellite television-delivery network) allow users to navigate among and locate desirable video clips, full motion videos (which may include television programs), images, music files, and other suitable programs (as described above). Consequently, media guidance is also necessary on modern non-television-centric platforms. For example, media guidance applications may be provided as on-line applications (i.e., provided on a web-site), or as stand-alone applications or clients on hand-held computers, personal digital assistants (PDAs) or cellular telephones. In some systems, users may control equipment remotely via a media guidance application. For example, users may access an online media guide and set recordings or other settings on their in home equipment. This may be accomplished by the on-line guide controlling the user's equipment directly or via another media guide that runs on the user's equipment.

For example, many households only receive cable television from one television provider (i.e., the primary television provider). Additionally, many households only receive Internet access from one Internet provider (i.e., the primary Internet provider). In some embodiments, despite separate distribution facilities being maintained for television and Internet media, the user may receive television service and Internet service from the same media provider (e.g., Comcast may provide both television and Internet service to the user). Alternatively, the television provider and the Internet provider may be different media providers (e.g., Comcast may provide television service while Verizon may provide Internet service to the user). Moreover, the user may choose to receive three different services (e.g., television, Internet and satellite radio) from one, two or three primary service providers. Regardless of the number of primary services providers, there are typically numerous primary distribution facilities 1304a in system 1300, but only one is shown in FIG. 13 to avoid overcomplicating the drawing.

Despite the large amounts of media that may be available to the user from the primary distribution facility 1304a, additional media may be available to the user from the secondary distribution facility 1304b that is shown in FIG. 13. The secondary distribution facility 1304b may be owned and/or operated by a service provider that is not the user's primary service provider. Similar to distribution facility 1304a, distribution facility 1304b may represent a single distribution facility and/or a plurality of distribution facilities that may be owned or operated by the same or different service providers. The present invention provides systems, computer readable media and methods that enable the media guidance application to access, search and provide programs offered by one or more distribution facilities 1304a and/or 1304b, and/or one or more programming sources 1302.

Distribution facility 1304, including distribution facilities 1304a and 1304b, may be connected to various user equipment devices 1308, 1310, and 1312. Such user equipment devices may be located, for example, in the homes of users. User equipment devices may include user television equipment 1310, user computer equipment 1312, or any other type of user equipment suitable for searching and/or accessing media. User equipment 1308 may be any type of user equipment (e.g., user television equipment, user computer equipment, cellular phones, handheld video players, gaming platforms, etc.) and, for simplicity, user equipment devices may be referred to generally as user equipment 1308.

User equipment devices 1308, 1310, and 1312 may receive media (such as television, music, web pages, etc.) and other data from distribution facility 1304 over communications paths, such as communications paths 1314, 1316, and 1318, respectively. User equipment devices 1308, 1310, 1312 may also transmit signals to distribution facility 1304 over paths 1314, 1316, and 1318, respectively. Paths 1314, 1316, and 1318 may be cables or other wired connections, free-space connections (e.g., for broadcast or other wireless signals), satellite links, or any other suitable link or combination of links.

A second approach illustrated in FIG. 13 by which media and media guidance are provided to end users is a non-television-centric approach. In this approach media such as video (which may include television programming), audio, images, web pages, or a suitable combination thereof, are provided to equipment of a plurality of users (e.g., user equipment 1308, user television equipment 1310, and user computer equipment 1312) by server 1330a via communications network 1326. Similar to distribution facility 1304, user access to server 1330a may also be controlled by at least one of the user's primary media servers. This approach is non-television-centric because media (e.g., television programming) is provided by and delivered at least partially, and sometimes exclusively, via equipment that have not traditionally been primarily focused on the television viewing experience. Non-television-centric equipment is playing a larger role in the television viewing experience.

Similarly, server 1330b may also provide users media and media guidance via a non-television-centric approach. In addition to the media made available by server 1330a, server 1330b may provide video (which may include television programming), audio, images, web pages, or a suitable combination thereof, to equipment of a plurality of users (e.g., user equipment 1308, user television equipment 1310, and user computer equipment 1312) via communications network 1326. User access to server 1330b, however, is controlled by at least one of the user's secondary media servers. Server 1330b may provide additional media that is not made available to the user by server 1330a. Servers 1330a and 1330b, and associated communication paths 1332a and 1332b, may generally be referred to as server 1330 and communication path 1332 for brevity. It will be understood that references to server 1330 and communication path 1332 may hereinafter refer generally to one or both of servers 1330a and 1330b, and communication paths 1332a and 1332b, respectively, as appropriate.

In some embodiments for this approach, communications network 1326 is the Internet. Server 1330 may provide for example, a web site that is accessible to the user's equipment and provides an on-line guidance application for the user. In such approaches, the user's equipment may be, for example, a PC or a hand-held device such as a PDA or web-enabled cellular telephone that incorporates a web browser. In other embodiments, server 1330 uses the Internet as a transmission medium but does not use the Web. In such approaches, the user's equipment may run a client application that enables the user to access media. Particular client applications may only be provided by server 1330. In still other approaches, communications network 1326 is a private communications network, such as a cellular phone network, that does not include the Internet, and is exclusive to a particular media server.

In yet other approaches, communications network 1326 may include a private communications network and the Internet. For example, a cellular telephone or other mobile-device service provider may provide Internet access to its subscribers via a private communications network, or may provide media such as video clips or television programs to its customers via the Internet and its own network.

The aforementioned approaches for providing media may, in some embodiments, be combined. For example, a distribution facility 1304 may provide a television-centric media delivery system, while also providing users' equipment (e.g., 1308, 1310 and 1312) with access to other non-television-centric delivery systems provided by server 1330. For example, a user's equipment may include a web-enabled set-top box or a television enabled PC. Distribution facility 1304 may, in addition to television and music programming, provide the user with Internet access whereby the user may access server 1330 via communications network 1326. Distribution facility 1304 may communicate with communications network 1326 over any suitable path 1334, such as a wired path, a cable path, fiber-optic path, satellite path, or combination of such paths.

Media guidance applications may be provided using any approach suitable for the type of media and distribution system for which the applications are used. Media guidance applications may be, for example, stand alone applications implemented on users' equipment. In other embodiments, media guidance applications may be client-server applications where only the client resides on the users' equipment. In still other embodiments, guidance applications may be provided as web sites accessed by a browser implemented on the users' equipment. Whatever the chosen implementation, the guidance application will require information about the media for which it is providing guidance. For example, titles or names of media, brief descriptions, or other information may be necessary to allow users to navigate among and find desired media selections.

In some television-centric embodiments, for example, the guidance application may be a stand-alone interactive television program guide that receives program guide data via one or more data feeds (e.g., a continuous feed, trickle feed, and/or data in the vertical blanking interval of a channel). The user's primary data source is shown in FIG. 13 as data source 1320a. Data source 1320a in system 1300 may include a program listings database that is used to provide the user with television program-related information such as scheduled broadcast times, titles, channels, ratings information (e.g., parental ratings and critic's ratings), detailed title descriptions, genre or category information (e.g., sports, news, movies, etc.), program format (e.g., standard definition, high definition) and information on actors and actresses. Data source 1320a may also be used to provide advertisements (e.g., program guide advertisements and advertisements for other interactive television applications), real-time data such as sports scores, stock quotes, news data, and weather data, application data for one or more media guidance applications or other interactive applications, and any other suitable data for use by system 1300. As another example, data source 1320a may provide data indicating the types of information that may be included in interactive media guidance overlays (e.g., at the request of the user, absent user modification, etc.).

The user may also have access to data owned, operated, controlled or provided by the data sources of media providers that are not one of the user's primary media providers. Data source 1320b may provide all the same data, features, etc. described above in reference to data source 1320a. Moreover, data source 1320b may provide, for example, additional data, different data or data less expensively than the data provided by data source 1320a. Data source 1320b may include a program listing database and other data associated with a secondary distribution facility 1304b, a secondary data programming source 1302, or any other source of programming.

Data sources 1320a and 1320b may generally be referred to as data source 1320. In one embodiment, data sources 1320a and 1320b may be consolidated, either physically, functionally, or both, to include substantially all data and program listings for all programming sources 1302, service providers 1342, servers 1330, and other sources of programming and data. In some embodiments of the present invention, on-demand media listings and other MOD portal database information may be stored in one or more data sources such as data source 1320. Data and information that may be included in on-demand media listings and MOD portal databases are described in further detail herein, for example, in connection with FIGS. 19-23.

Program guide data may be provided to user equipment, including user equipment located on home network 1313, using any suitable approach. For example, program schedule data and other data may be provided to the user equipment on a television channel sideband, in the vertical blanking interval of a television channel, using an in-band digital signal, using an out-of-band digital signal, or by any other suitable data transmission technique. Program schedule data and other data may be provided to user equipment on multiple analog or digital television channels. Program schedule data and other data may be provided to the user equipment with any suitable frequency (e.g., continuously, daily, in response to a request from user equipment, etc.).

In some television-centric embodiments, guidance data from data source 1320 may be provided to users' equipment using a client-server approach. For example, a guidance application client residing on the user's equipment may initiate sessions with server 1340 and/or 1340b to obtain guidance data when needed. In some embodiments, the guidance application may initiate sessions with server 1340 via a home network server (e.g., a server located in home network 1313 that supports the user equipment devices located in home network 1313).

Data source 1320 may represent multiple data sources, although only two data sources are shown in FIG. 13 to avoid overcomplicating the drawing. For example, a separate data source may be associated with each of a plurality of primary or secondary television broadcasters and may provide data that is specific to those broadcasters (e.g., advertisements for future programming of the broadcasters, logo data for displaying broadcasters' logos in program guide display screens, etc.). Data source 1320, as well as any other system components of FIG. 13, may be provided using equipment at one or more locations. Systems components are drawn as single boxes in FIG. 13 to avoid overcomplicating the drawings.

Data source 1320 may provide data to distribution facility 1304 over communications path 1322 for distribution to the associated user equipment and home network 1313 (discussed below) over paths 1314, 1316, 1318, and 1319 (e.g., when data source 1320 is located at a main facility). Communications path 1322 may be any suitable communications path such as a satellite communications path or other wireless path, a fiber-optic or other wired communications path, a path that supports Internet communications, or other suitable path or combination of such paths.

In some television-centric and non-television centric approaches, data source 1320 may provide guidance data directly to user equipment 1308 over path 1324, communications network 1326, and path 1328 (e.g., when data source 1320 is located at a facility such as programming source 1302). In some embodiments of the present invention, data source 1320 may provide guidance data directly to user equipment located on home network 1313 (discussed below) over path 1324, communications network 1326, and path 1339 (e.g., when data source 1320 is located at a facility such as programming source 1302). Paths 1324, 1328, and 1339 may be wired paths such as telephone lines, cable paths, fiber-optic paths, satellite paths, wireless paths, any other suitable paths or a combination of such paths. Communications network 1326 may be any suitable communications network, such as the Internet, the public switched telephone network, or a packet-based network.

User equipment devices, including user equipment devices located on home network 1313 (discussed below), such as user television equipment and personal computers, may use the program schedule data and other interactive media guidance application data to display program listings and other information (e.g., information on digital music) for the user. An interactive television program guide application or other suitable interactive media guidance application may be used to display the information on the user's display (e.g., in one or more overlays that are displayed on top of video for a given television channel). Interactive displays may be generated and displayed for the user using any suitable approach. In one suitable approach, distribution facility 1304, server 1330, or another facility, may generate application display screens and may transmit the display screens to user equipment for display. In another suitable approach, user equipment may store data for use in one or more interactive displays (e.g., program schedule data, advertisements, logos, etc.), and an interactive media guidance application implemented at least partially on the user equipment may generate the interactive displays based on instructions received from distribution facility 1304, server 1330 or another facility. In some embodiments of the present invention, user equipment may store only the data that is used to generate the interactive television displays (e.g., storing logo data for a particular television broadcaster only if the logo is to be included in one or more interactive television displays). In some embodiments of the present invention, user equipment may store data that is not necessarily used to generate the interactive television displays (e.g., storing advertisements associated with a particular television broadcaster that may or may not be displayed depending on, for example, the outcome of negotiations with the television broadcaster). Any other suitable approach or combination of approaches may be used to generate and display interactive overlays for the user.

In still other embodiments, interactive media guidance applications (television-centric and non-television centric) may be provided online as, for example, websites. For example, server 1330 may provide an online interactive television program guide. As another example, user equipment 1308 may be a mobile device, such as a cellular telephone or personal digital assistant (PDA). The mobile device may be web-enabled to allow the user to access an on-line guidance application (which may be modified from its original version to make it appropriate for a cellular phone). Alternatively, the mobile device may have an applet that communicates with server 1330 to obtain guidance data via the Internet.

Server 1330 may receive program schedule data and other data from data source 1320 via communications path 1324, communications network 1326, and communications path 1332 or via another suitable path or combination of paths. Path 1332 may be a satellite path, fiber-optic path, wired path, or any other path or combination of paths. User equipment 1308 may access the on-line interactive media guidance application and other sources from server 1330 via communications path 1328. User equipment 1308 may also access the application and other services on server 1330 via communications path 1314, distribution facility 1304, and communications path 1334. For example, a cable modem or other suitable equipment may be used by user equipment 1308 to communicate with distribution facility 1304.

User equipment such as user television equipment 1310, user computer equipment 1312, and user equipment located on home network 1313 may access the on-line interactive media guidance application and server 1330 using similar arrangements. User television equipment 1310 may access the on-line interactive media guidance application and server 1330 using communications path 1336 or using path 1316, distribution facility 1304, and path 1334. User computer equipment 1312 may access the on-line interactive media guidance application and server 1330 using communications path 1338 or using path 1318, distribution facility 1304, and path 1334. User equipment located on home network 1313 may access the on-line media guidance application and server 1330 using communications path 1339 or using path 1319, distribution facility 1304, and path 1334. Paths 1336, 1338, and 1339 may be any suitable paths such as wired paths, cable paths, fiber-optic paths, wireless paths, satellite paths, or a combination of such paths.

In some embodiments, system 1300 may support other interactive applications in addition to the interactive media guidance applications. Such applications may be implemented using any suitable approach. For example, the interactive applications may be implemented locally on the user equipment or in a distributed fashion (e.g., using a client-server architecture in which the user equipment serves at least partly, and for at least some of the time, as the client and a server, such as server 1340 at distribution facility 1304, server 1330, or other suitable equipment acts as the server). Other distributed architectures may also be used if desired. Moreover, some or all of the features of the interactive applications of system 1300 (including the media guidance application) may be provided using operating system software or middleware software. Such operating system software and middleware may be used instead of or in combination with application-level software. In yet other approaches, interactive applications may also be supported by servers or other suitable equipment at one or more service providers such as service provider 1342a or service provider 1342b. Regardless of the particular arrangement used, the software that supports these features may be referred to as an application or applications.

In another example, an interactive application such as a home shopping service may be supported by a service provider such as service provider 1342 that has sales representatives, order fulfillment facilities, account maintenance facilities, and other equipment for supporting interactive home shopping features. A home shopping application that is implemented using the user equipment may be used to access the service provider to provide such features to the user. The user equipment may access service provider 1342 via distribution facility 1304 and communications path 1344 or via communications network 1326 and communications path 1346. Communications paths such as paths 1344 and 1346 may be any suitable paths such as wired paths, cable paths, fiber-optic paths, satellite paths, or a combination of such paths.

Another example of an interactive application is a home banking application. A home banking service may be supported using personnel at facilities such as service provider 1342. An interactive home banking application that is implemented using the user equipment may access the home banking service via distribution facility 1304 and communications path 1344 or via communications network 1326 and communications path 1346.

If desired, an interactive media guidance application such as a network-based video recorder or a video-on-demand application may be supported using server 1340, server 1330, a home network server, or equipment at service provider 1342. Video-on-demand or other on-demand content and video recorded using a network-based video recorder arrangement may be stored on server 1340 or server 1330 or a home network server or at a service provider 1342 and may be provided to the user equipment when requested by users. An interactive television program guide, for example, may be used to support the functions of a personal video recorder (sometimes called a digital video recorder) that is implemented using user equipment 1308. Illustrative equipment that may be used to support personal video recorder functions include specialized personal video recorder devices, integrated receiver decoders (IRDS), set-top boxes with integrated or external hard drives, or personal computers with video recording capabilities.

Interactive applications such as media guidance applications (e.g., interactive television program guide applications, and video-on-demand applications), home shopping applications, home banking applications, game applications, and other applications (e.g., applications related to e-mail and chat or other communications functions, etc.) may be provided as separate applications that are accessed through a navigation shell application (i.e., a menu application with menu options corresponding to the applications). The features of such applications may be combined. For example, games, video-on-demand services, home shopping services, network-based video recorder functions, personal video recorder functions, navigational functions, program guide functions, communications functions, and other suitable functions may be provided using one application or any other suitable number of applications. The one or more applications may display various overlays on user equipment including, for example, interactive television information on top of video for a given television channel. One or more media providers may also provide the one or more applications to the user.

Interactive television program guide applications, home banking applications, home shopping applications, network-based video recorder and personal video recorder applications, video-on-demand applications, gaming applications, communications applications, and navigational applications are only a few illustrative examples of the types of interactive media guidance and other applications that may be supported by system 1300. Other suitable interactive applications that may be supported include news services, web browsing, web broadcasting, online television and other Internet services, and interactive wagering services (e.g., for wagering on horse races, sporting events, and the like). Interactive television overlays that are displayed by these applications may also be customized in accordance with the present invention.

Users may have multiple types of user equipment by which they access media and obtain media guidance. For example, some users may have home networks that are accessed by in-home and mobile devices. As shown in FIG. 13, home network 1313 communicates with distribution facility 1304 and server 1330 over paths 1319 and 1339 (and, in the case of server 1330, communications network 1326). Such home networks 1313 may be located, for example, in homes of users or distributed, for example, among homes of users. Home networks 1313 may each include a plurality of interconnected user equipment devices, such as, for example user equipment devices 1308, 1310 and 1312. In some embodiments, users may control in-home devices via a media guidance application implemented on a remote device. For example, users may access an online media guidance application on a website via a personal computer at their office, or a mobile device such as a PDA or web-enabled cellular telephone. The user may set settings (e.g., recordings, reminders, or other settings) on the on-line guidance application to control the user's in-home equipment. The on-line guide may control the user's equipment directly, or by communicating with a media guidance application on the user's in-home equipment.

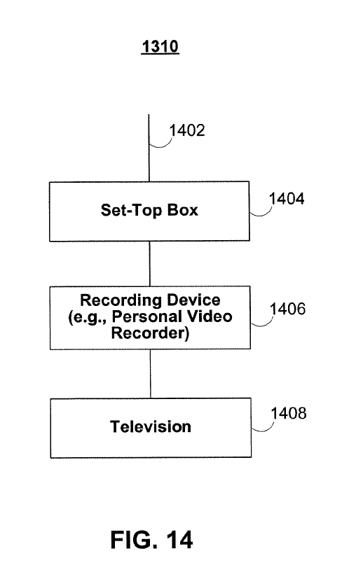

FIGS. 14-18 show illustrative arrangements for user equipment. An illustrative set-top box-based arrangement for user equipment 1310 is shown in FIG. 14. User television equipment 1310 may be stand-alone or a part of home network 1313 (FIG. 13). Input/output 1402 may be connected to communications paths such as paths 1316 and 1336 (FIG. 13). Input/output functions may be provided by one or more wires or communications paths, but are shown as a single path in FIG. 14 to avoid overcomplicating the drawing. Television programming, program guide data, and any other suitable interactive media guidance application data or other data may be received using input/output 1402. Commands and requests and other data generated as a result of user interactions with the interactive media guidance application may also be transmitted over input/output 1402.

Set-top box 1404 may be any suitable analog or digital set-top box (e.g., a cable set-top box). Set-top box 1404 may contain an analog tuner for tuning to a desired analog television channel (e.g., a channel comprising television programming, interactive television data, or both). Set-top box 1404 may also contain digital decoding circuitry for receiving digital television channels (e.g., channels comprising television or music programming, interactive television data, etc.). Set-top box 1404 may also contain a high-definition television tuner for receiving and processing high-definition television channels. Analog, digital, and high-definition channels may be handled together if desired. Multiple tuners may be provided (e.g., to handle simultaneous watch and record functions or picture-in-picture (PIP) functions). Box 1404 may be an integrated receiver decoder (IRD) that handles satellite television. If desired, box 1404 may have circuitry for handling cable, over-the-air broadcast, and satellite content.

Set-top box 1404 may be configured to output media, such as television programs, in a preferred format. Because television programs may be received in a variety of formats, set-top box 1404 may contain scaler circuitry for upconverting and downconverting television programs into the preferred output format used by set-top box 1404. For example, set-top box 1404 may be configured to output television programs in 720p. In this example, the scaler circuitry may upconvert standard-definition television programs having 480 lines of vertical resolution to 720p format and downconvert certain high-definition television programs having 1080 lines of vertical resolution to 720p format.

Box 1404 may include a storage device (e.g., a digital storage device such as a hard disk drive) for providing recording capabilities. Box 1404 may also be connected to a recording device 1406 such as a video cassette recorder, flash memory, personal video recorder, optical disc recorder, or other device or devices with storage capabilities. In some embodiments, box 1404 may be configured to record either standard-definition television programs or high-definition television programs. In some embodiments, box 1404 may be configured to record both standard-definition television programs and high-definition television programs.

Set-top box 1404 contains a processor (e.g., a microcontroller or microprocessor or the like) that is used to execute software applications. Set-top box 1404 may contain memory such as random-access memory for use when executing applications. Nonvolatile memory may also be used (e.g., to launch a boot-up routine and other instructions). Hard disk storage in box 1404 or in recording device 1406 may be used to back up data and to otherwise support larger databases and storage requirements than may be supported using random-access memory approaches. Hard disk storage in box 1404 or in recording device 1406 may also be used to store and back up program guide settings or saved user preferences.

Set-top box 1404 may have infrared (IR) or other communications circuitry for communicating with a remote control or wireless keyboard. Set-top box 1404 may also have dedicated buttons and a front-panel display. The front-panel display may, for example, be used to display the current channel to which the set-top box is tuned.

Set-top box 1404 may also have communications circuitry such as a cable modem, an integrated services digital network (ISDN) modem, a digital subscriber line (DSL) modem, a telephone modem, or a wireless modem for communications with other equipment. Such communications may involve the Internet or any other suitable communications networks or paths. If desired, the components of set-top box 1404 may be integrated into other user equipment (e.g., a television or video recorder).

Recording device 1406 may be used to record videos provided by set-top box 1404. For example, if set-top box 1404 is tuned to a given television channel, the video signal for that television channel may be passed to recording device 1406 for recording on a videocassette, compact disc, digital video disk, or internal hard drive or other storage device. In some embodiments, recording device 1406 may be configured to record either standard-definition television programs or high-definition television programs. In some embodiments, recording device 1406 may be configured to record both standard-definition television programs and high-definition television programs. Recording device 1406 may have communications circuitry such as a cable modem, an ISDN modem, a DSL modem, or a telephone modem for communications with other equipment. Such communications may involve the Internet or any other suitable communications networks or paths. The components of recording device 1406 may be integrated into other user equipment (e.g., a television, stereo equipment, etc.).

Recording device 1406 may be controlled using a remote control or other suitable user interface. If desired, video recorder functions such as start, stop, record and other functions for device 1406 may be controlled by set-top box 1404. For example, set-top box 1404 may control recording device 1406 using infrared commands directed toward the remote control inputs of recording device 1406 or set-top box 1404 may control recording device 1406 using other wired or wireless communications paths between box 1404 and device 1406.

The output of recording device 1406 may be provided to television 1408 for display to the user. In some embodiments, television 1408 may be capable of displaying high-definition programming (i.e., HDTV-capable). If desired, multiple recording devices 1406 or no recording device 1406 may be used. If recording device 1406 is not present or is not being actively used, the video signals from set-top box 1404 may be provided directly to television 1408. Any suitable television or monitor may be used to display the video. For example, if the video is in a high-definition format, an HDTV-capable television or monitor is required to display the video. In the equipment of FIG. 14 and the other equipment of system 1300 (FIG. 13), the audio associated with various video items is typically distributed with those video items and is generally played back to the user as the videos are played. In some embodiments, the audio may be distributed to a receiver (not shown), which processes and outputs the audio via external speakers (not shown).

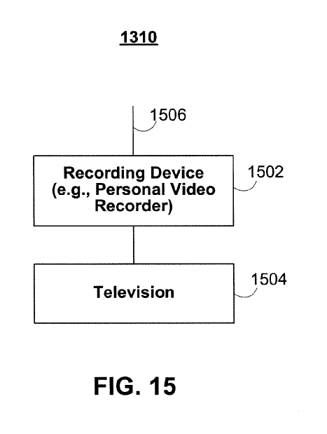

Another illustrative arrangement for user television equipment 1310 (FIG. 13) is shown in FIG. 15. User television equipment 1310 may be stand-alone or a part of home network 1313 (FIG. 13). In the example of FIG. 15, user television equipment 1310 includes a recording device 1502 such as a digital video recorder (e.g., a personal video recorder (PVR)) that uses a hard disk or other storage for recording video. Recording device 1502 may alternatively be a digital video disc recorder, compact disc recorder, videocassette recorder, or other suitable recording device. Equipment 1310 of FIG. 15 may also include a television 1504. In some embodiments, television 1504 may be HDTV-capable. Input/output 1506 may be connected to communications paths such as paths 1316 and 1336 (FIG. 13). Television programming, program schedule data, and other data (e.g., advertisement data, data indicating one or more television channels for which the display of an overlay is to be customized, etc.) may be received using input/output 1506. Commands and requests and other data from the user may be transmitted over input/output 1506.

Recording device 1502 may contain at least one analog tuner for tuning to a desired analog television channel (e.g., to display video for a given television channel to a user, to receive program guide data and other data) and multiple other tuners may also be provided. Recording device 1502 may also contain digital decoding circuitry for receiving digital television programming, music programming, program guide data and other data on one or more digital channels. Recording device 1502 may also contain circuitry for receiving high-definition television channels. If desired, recording device 1502 may contain circuitry for handling analog, digital, and high-definition channels. Recording device 1502 also contains a processor (e.g., a microcontroller or microprocessor or the like) that is used to execute software applications. Recording device 1502 may contain memory such as random-access memory for use when executing applications. Nonvolatile memory may also be used to store a boot-up routine or other instructions. The hard disk and other storage in recording device 1502 may be used to support databases (e.g., program guide databases or other interactive television application databases). The hard disk or other storage in recording device 1502 may also be used to record video such as television programs or video-on-demand content or other content provided to recording device 1502 over input/output 1506.

Recording device 1502 may have IR communications circuitry or other suitable communications circuitry for communicating with a remote control. Recording device 1502 may also have dedicated buttons and a front-panel display. The front-panel display may, for example, be used to display the current channel to which the recording device is tuned.

Recording device 1502 may also have communications circuitry such as a cable modem, an ISDN modem, a DSL modem, a telephone modem, or a wireless modem for communications with other equipment. Such communications may involve the Internet or other suitable communications networks or paths.

If desired, recording device 1502 may include a satellite receiver or other equipment that has wireless communications circuitry for receiving satellite signals.

Recording device 1502 of FIG. 15 or recording device 1406 of FIG. 14 may record new video while previously recorded video is being played back on television 1504 or 1408. This allows users to press a pause button during normal television viewing. When the pause button is pressed, the current television program is stored on the hard disk of digital video recorder 1502. When the user presses play, the recorded video may be played back. This arrangement allows the user to seamlessly pause and resume television viewing. Recording devices 1502 and 1406 may also be used to allow a user to watch a previously-recorded program while simultaneously recording a new program.

The set-top box arrangement of FIG. 14 and the personal video recorder with a built-in set-top box arrangement of FIG. 15 are merely illustrative. Other arrangements may be used if desired. For example, user television equipment may be based on a WebTV box, a personal computer television (PC/TV), or any other suitable television equipment arrangement. If desired, the functions of components such as set-top box 1404, recording device 1502, a WebTV box, or PC/TV or the like may be integrated into a television or personal computer or other suitable device.

An illustrative remote control 1600 for operating user television equipment 1310 (FIG. 13) or suitable user computer equipment 1312 is shown in FIG. 16. Remote control 1600 is only illustrative and any other suitable user input interface may be used to operate user equipment (e.g., a mouse, trackball, keypad, keyboard, touch screen, voice recognition system, etc.). Remote control 1600 may have function keys 1602 and other keys 1604 such as keypad keys, power on/off keys, pause, stop, fast-forward and reverse keys. Volume up and down keys 1606 may be used for adjusting the volume of the audio portion of a video. Channel up and down keys 1608 may be used to change television channels and to access content on virtual channels. Cursor keys 1610 may be used to navigate on-screen menus. For example, cursor keys 1610 may be used to position an on-screen cursor, indicator, or highlight (sometimes all generically referred to herein as a highlight or highlight region) to indicate interest in a particular option or other item on a display screen that is displayed by the interactive television application.

OK key 1612 (sometimes called a select or enter key) may be used to select on-screen options that the user has highlighted.

Keys 1602 may include RECORD key 1614 for initiating recordings. MENU button 1616 may be used to direct an interactive media guidance application to display a menu on the user's display screen (e.g., on television 1408 or 1504 or on a suitable monitor or computer display). INFO button 1618 may be used to direct an interactive media guidance application to display an information display screen. For example, when a user presses INFO key 1618 while video for a given television channel is displayed for the user, an interactive television program guide may display a FLIP/BROWSE overlay including program schedule information for the current program on the given television channel on top of the video. As another example, when a particular program listing in an interactive television program listings display screen is highlighted, the user pressing INFO button 1618 may cause an interactive television program guide to provide additional program information associated with that program listing (e.g., a program description, actor information, schedule information, etc.).

LOCK button 1620 may be used to modify access privileges. For example, a parent may use LOCK button 1620 or on-screen options to establish parental control settings for the interactive media guidance application. The parental control settings may be time-based settings (e.g., to prevent a child from watching television during a particular time block, such as from 3:00 PM to 5:00 PM). The parental control settings may also be used to, for example, block programming based on rating, channel, and program title. A locked or blocked program (or other media) is typically not viewable until the interactive media guidance application is provided with a suitable personal identification number (PIN). Once this PIN has been entered, the interactive media guidance application will unlock the user's equipment and allow the locked content to be accessed.

EXIT button 1622 may be used to exit the interactive media guidance application or to exit a portion of the interactive media guidance application (e.g., to cause an interactive television program guide to remove a FLIP, BROWSE, or other interactive television overlay from the display screen). GUIDE button 1624 may be used to invoke an interactive television program guide (e.g., a program guide menu screen, program listings screen, or other program guide screen).

SEARCH button 1626 may be used to recall saved searches or begin configuring a new search. SEARCH button 1626 may be used to recall the results of a search or set of searches. SEARCH button 1626 may also be used to display a Search screen and/or menu.

The keys shown in FIG. 16 are merely illustrative. Other keys or buttons may be provided if desired. For example, a music button may be used to access music with the interactive media guidance application. An edit button may be used to edit stored content (e.g., to remove commercials, remove portions of a video, etc.). Alphanumeric buttons may be used to enter alphanumeric characters. A last or back button may be used to browse backward in the interactive media guidance application (e.g., to return to a previous channel, web page, or other display screen). Video recorder function buttons such as a play button, pause button, stop button, rewind button, fast-forward button, and record button, may be used to control video recorder functions (local or network-based) in system 1300 (FIG. 13). A help key may be used to invoke help functions such as context-sensitive on-screen help functions.

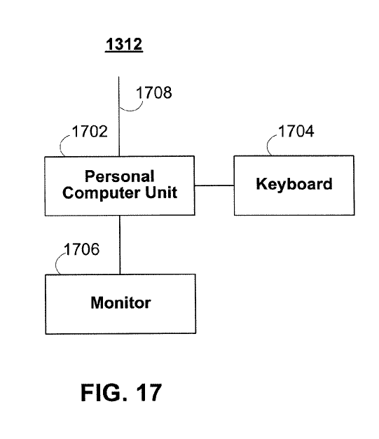

Illustrative user computer equipment 1312 (FIG. 13) is shown in FIG. 17. User computer equipment 1312 may be stand-alone or a part of home network 1313 (FIG. 13). In the arrangement of FIG. 17, personal computer unit 1702 may be controlled by the user using keyboard 1704 and/or other suitable user input device such as a trackball, mouse, touch pad, touch screen, voice recognition system, or a remote control, such as remote control 1600 of FIG. 16. Video content, such as television programming or web pages having video elements, and interactive media guidance application display screens may be displayed on monitor 1706. Television and music programming, media guidance application data (e.g., television program guide data), video-on-demand content, video recordings played back from a network-based video recorder, and other data may be received from paths 1318 and 1338 (FIG. 13) using input/output 1708. User commands and other information generated as a result of user interactions with the interactive media guidance application and system 1300 (FIG. 13) may also be transmitted over input/output 1708.

Personal computer unit 1702 may contain a television or video card, such as a television tuner card, for decoding analog, digital, and high-definition television channels and for handling streaming video content. Multiple video cards (e.g., tuner cards) may be provided if desired. An illustrative television tuner card that may be used may contain an analog television tuner for tuning to a given analog channel, digital decoding circuitry for filtering out a desired digital television or music channel from a packetized digital data stream, and a high-definition television tuner for tuning to a high-definition channel. Any suitable card or components in computer unit 1702 may be used to handle video and other content delivered via input/output line 1708 if desired.

Personal computer unit 1702 may contain one or more processors (e.g., microprocessors) that are used to run the interactive media guidance application or a portion of the interactive media guidance application.

Personal computer unit 1702 may include a hard drive, a recordable DVD drive, a recordable CD drive, or other suitable storage device or devices that stores video, program guide data, and other content. The interactive media guidance application and personal computer unit 1702 may use a storage device or devices to, for example, provide the functions of a personal video recorder.

User equipment, such as user equipment 1308, user television equipment 1310, user computer equipment 1312, and user equipment located on home network 1313 (FIG. 13), may be used with network equipment such as server 1330, server 1340, a home network server, and equipment at service providers such as service provider 1342 of FIG. 13 to provide network-based video recording functions. Video recording functions may be provided by storing copies of television programs and other video content on a remote server (e.g., server 1330 or server 1340 or a home network server) or other network-based equipment, such as equipment at a service provider such as service provider 1342.

Video recordings may be made in response to user commands that are entered at user equipment 1308 or user equipment located on home network 1313 (FIG. 13). In a personal video recorder arrangement, the interactive media guidance application may be used to record video locally on the user equipment in response to the user commands. In a network-based video recorder arrangement, the interactive media guidance application may be used to record video or to make virtual recordings (described below) on network equipment such as server 1330, server 1340, a home network server, or equipment at service provider 1342 in response to the user commands. The user commands may be provided to the network equipment over the communications paths shown in FIG. 13. The personal video recorder arrangement and the network-based video recorder arrangement can support functions such as fast-forward, rewind, pause, play, and record.

To avoid unnecessary duplication in a network-based video recorder environment, system 1300 may provide network-based video recording capabilities by using virtual copies or recordings. With this approach, each user may be provided with a personal area on the network that contains a list of that user's recordings. The video content need only be stored once (or a relatively small number of times) on the network equipment, even though a large number of users may have that video content listed as one of their recordings in their network-based video recorder personal area. Personal settings or any other suitable data may be stored in a user's personal area on the network.

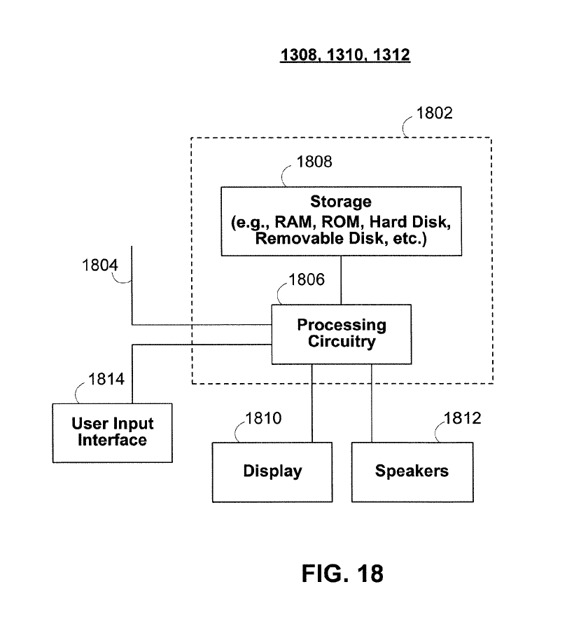

The user television equipment and user computer equipment arrangements described above are merely illustrative. A more generalized embodiment of illustrative user equipment 1308, 1310, and 1312 (FIG. 13) and user equipment located on home network 1313 (FIG. 13) is shown in FIG. 18. Control circuitry 1802 is connected to input/output 1804. Input/output 1804 may be connected to one or more communications paths such as paths 1314, 1316, 1318, 1328, 1336, and 1338 of FIG. 13. Media (e.g., television programming, music programming, other video and audio and web pages) may be received via input/output 1804 (e.g., from programming sources 1302, servers or other equipment, such as server 1330, service providers such as service provider 1342, distribution facility 1304, etc.). Interactive media guidance application data, such as program schedule information for an interactive television program guide, may be received from data source 1320 via input/output 1804. Input/output 1804 may also be used to receive data from data source 1320 for other interactive television applications. The user may use control circuitry 1802 to send and receive commands, requests, and other suitable data using input/output 1804.

Control circuitry 1802 may be based on any suitable processing circuitry 1806 such as processing circuitry based on one or more microprocessors, microcontrollers, digital signal processors, programmable logic devices, etc. In some embodiments, control circuitry 1802 executes instructions for an interactive media guidance application or other interactive application (e.g., web browser) from memory. Memory (e.g., random-access memory and read-only memory), hard drives, optical drives, or any other suitable memory or storage devices may be provided as storage 1808 that is part of control circuitry 1802. Tuning circuitry such as one or more analog tuners, one or more MPEG-2 decoders or other digital video circuitry, high-definition tuners, or any other suitable tuning or video circuits or combinations of such circuits may also be included as part of circuitry 1802. Encoding circuitry (e.g., for converting over-the-air, analog, or digital signals to MPEG signals for storage) may also be provided. The tuning and encoding circuitry may be used by the user equipment to receive and display, play, or record a particular television or music channel or other desired audio and video content (e.g., video-on-demand content or requested network-based or local video recorder playback). Television programming and other video and on-screen options and information may be displayed on display 1810. Display 1810 may be a monitor, a television, or any other suitable equipment for displaying visual images. In some embodiments, display 1810 may be HDTV-capable. Speakers 1812 may be provided as part of a television or may be stand-alone units. Digital music and the audio component of videos displayed on display 1810 may be played through speakers 1812. In some embodiments, the audio may be distributed to a receiver (not shown), which processes and outputs the audio via speakers 1812.

A user may control the control circuitry 1802 using user input interface 1814. User input interface 1814 may be any suitable user interface, such as a mouse, trackball, keypad, keyboard, touch screen, touch pad, voice recognition interface, or a remote control.

1. A method for using an interactive television application to provide interactive displays, comprising:
providing a user with an opportunity to indicate a desire to access a first set of search results generated based on a first set of search criteria; and
in response to the user indicating a desire to access the first set of search results, displaying on a display screen a first set of mosaic listings having different levels of relevance based on similarities between the first set of search criteria and a first set of programs associated with the first set of search results, wherein:
the first set of mosaic listings are displayed in a manner that indicates the different levels of relevance;
included among the first set of mosaic listings are mosaic listings having a greater level of relevance that are graphically accentuated in contrast to mosaic listings having a lower level of relevance;
allowing the user to select a first mosaic listing associated with a first program included in the first set of search results; and
generating, with the interactive television application, a second set of search criteria, at least partially different from the first set of search criteria, based at least partially on the first program and at least partially on the first set of search criteria.

2. The method of claim 1 further comprising
displaying on the display screen a second set of mosaic listings in response to the user selecting the first mosaic listing.

3. The method of claim 1, wherein the generating the second set of search criteria includes comparing attributes associated with the first program to attributes associated with the first set of search criteria.

4. The method of claim 1 further comprising displaying on the display screen a second set of search results that include a second set of mosaic listings associated with a second set of programs that match the second set of search criteria, wherein:
the second set of mosaic listings have different levels of relevance;
the second set of mosaic listings are displayed to indicate the different levels of relevance of the second set of programs;
mosaic listings associated with programs having a greater level of relevance are graphically accentuated in contrast to mosaic listings associated with programs having a lower level of relevance; and
at least one program of the second set of programs is associated with a different level of relevance based on the second set of search criteria as compared to the at least one program's level of relevance based on the first set of search criteria.

5. The method of claim 1, wherein the first set of mosaic listings displayed is generated based at least partially on a user profile.

6. The method of claim 1, wherein the generating the second set of search criteria is based at least partially on a user profile.

7. The method of claim 1, wherein at least one of the mosaic listings included with the first set of mosaic listings is associated with a program that is indirectly related to the first set of search criteria.

8. The method of claim 1, wherein the first set of mosaic listings are associated with programs made available by multiple media providers.

9. The method of claim 1 further comprising
providing to the user the program associated with the selected first mosaic listing.

10. The method of claim 4 further comprising:
allowing the user to select a second mosaic listing associated with a second program included in the second set of search results; and
providing the second program associated with the second mosaic listing.

11. The method of claim 9, wherein the program is a television program.

12. The method of claim 9, wherein the program is a video program.

13. The method of claim 9, wherein the program is available on demand.

14. The method of claim 9, wherein the program is a music video.

15. The method of claim 9, wherein the program is a musical song.

16. The method of claim 9, wherein the program is data available via the Internet.

17. The method of claim 1 further comprising
providing a promotional preview of the program associated with the selected first mosaic listing.

18. The method of claim 4 further comprising:
allowing the user to select a second mosaic listing associated with a second program included in the second set of search results; and
providing a promotional preview of the second program associated with the second mosaic listing.

19. The method of claim 6, wherein the user profile is at least partially based on the user rating of one or more programs.

20. The method of claim 1, wherein the mosaic listings having the greater level of relevance are graphically accentuated by different positioning on the display screen in contrast to the positioning on the display screen of mosaic listings having the lower level of relevance.

21. The method of claim 1, wherein the mosaic listings having the greater level of relevance are graphically accentuated by different sizing in contrast to the sizing of the mosaic listings having the lower level of relevance.

22. An interactive media guide system that provides interactive displays, comprising:
an interactive media guidance application implemented at least partially on circuitry configured to:
provide a user with an opportunity to indicate a desire to access a first set of search results generated based on a first set of search criteria; and
in response to the user indicating a desire to access the first set of search results, display on a display screen a first set of mosaic listings having different levels of relevance based on similarities between a first set of search criteria and a first set of programs associated with the first set of search results, wherein:
the first set of mosaic listings are displayed in a manner that indicates the different levels of relevance;
included among the first set of mosaic listings are mosaic listings having a greater level of relevance that are graphically accentuated in contrast to mosaic listings having a lower level of relevance;
allow the user to select a first mosaic listing associated with a first program included in the first set of search results; and
generate a second set of search criteria, at least partially different from the first set of search criteria, based at least partially on the first program and at least partially on the first set of search criteria.

23. The system of claim 22, wherein the circuitry is further configured to display on the display screen a second set of mosaic listings in response to the user selecting the first mosaic listing.

24. The system of claim 22, wherein the circuitry is further configured to generate the second set of search criteria by comparing attributes associated with the first program to attributes associated with the first set of search criteria.

25. The system of claim 22, wherein the circuitry is further configured to:
display on the display screen a second set of search results that include a second set of mosaic listings associated with a second set of programs that match the second set of search criteria; and
differentiate different levels of relevance of the second set of programs, wherein:
the mosaic listings are displayed to indicate the different levels of relevance of the second set of programs;
mosaic listings associated with programs having a greater level of relevance are graphically accentuated in contrast to mosaic listings associated with programs having a lower level of relevance; and
at least one program of the second set of programs is associated with a different level of relevance based on the second set of search criteria as compared to the at least one program's level of relevance based on the first set of search criteria.

26. The system of claim 22, wherein the circuitry is further configured to generate the display including the first set of mosaic listings, wherein the first set of mosaic listings displayed is based at least partially on a user profile.

27. The system of claim 22, wherein the circuitry is further configured to generate the second set of search criteria based at least partially on a user profile.

28. The system of claim 22, wherein at least one of the mosaic listings included with the first set of mosaic listings is associated with a program that is indirectly related to the first set of search criteria.

29. The system of claim 22, wherein the circuitry is further configured to associate the first set of mosaic listings with programs made available by multiple media providers.

30. The system of claim 22, wherein the circuitry is further configured to provide to the user the program associated with the selected first mosaic listing.

31. The system of claim 25, wherein the circuitry is further configured to:
allow the user to select a second mosaic listing associated with a second program included in the second set of search results; and
provide the second program associated with the second mosaic listing.

32. The system of claim 30, wherein the program is a television program.

33. The system of claim 30, wherein the program is a video program.

34. The system of claim 30, wherein the program is available on demand.

35. The system of claim 30, wherein the program is a music video.

36. The system of claim 30, wherein the program is a musical song.

37. The system of claim 30, wherein the program is data available via the Internet.

38. The system of claim 22, wherein the circuitry is further configured to provide a promotional preview of the program associated with the selected first mosaic listing.

39. The system of claim 25, wherein the circuitry is further configured to:
allow the user to select a second mosaic listing associated with a second program included in the second set of search results, wherein the second mosaic listing is associated with a second program; and
provide a promotional preview of the second program.

40. The system of claim 27, wherein the user profile is at least partially based on the user rating one or more programs.

41. The system of claim 22, wherein the mosaic listings having the greater level of relevance are graphically accentuated by different positioning on the display screen in contrast to the positioning on the display screen of mosaic listings having the lower level of relevance.

42. The system of claim 22, wherein the mosaic listings having the greater level of relevance are graphically accentuated by different sizing in contrast to the sizing of the mosaic listings having the lower level of relevance.
